(19) United States
(12) Patent Application Publication
(10) Pub. No.: US 2010/0037146 A1
(43) Pub. Date: Feb. 11, 2010

(54) Systems, Methods, and Graphical User Interfaces for Generating or Managing an Action Plan for a User

(75) Inventors: Scott Belsky, New York, NY (US); David Stein, New York, NY (US); Matias Corea, Brooklyn, NY (US); Chris Henry, Hoboken, NJ (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: BEHANCE LLC, New York, NY (US)

(21) Appl. No.: 12/502,146

(22) Filed: Jul. 13, 2009

Related U.S. Application Data
(60) Provisional application No. 61/080,221, filed on Jul. 11, 2008.

(51) Int. Cl. G06F 3/01; G06F 15/16

(52) U.S. Cl. 715/744; 715/751; 709/206

(57) ABSTRACT

Systems, methods, and graphical user interfaces for generating an action plan for a user are provided. In one embodiment, an application for generating the action plan may be opened, an instruction to generate the action item from a user may be received, information relating to the action item from the user may be received, the action item may be generated using the received information and the generated action item may be displayed to the user. In one embodiment, instructions may be received from a first user to delegate an action item to a second user, the delegated action item may be sent to the second user, a decision from the second user regarding his acceptance of the delegated action item may be received, and the decision may be displayed to the first user.

### CROSS REFERENCE TO RELATED APPLICATIONS

The present application claims the benefit of U.S. Provisional Application Ser. No. 60/610,506, filed on Sep. 15, 2004, which is incorporated herein by reference in its entirety.

### BACKGROUND

Existing project management systems are traditionally centered around one or more projects. Projects generally have tasks or action items associated with them. These tasks are typically organized within a project in a uniform manner and format so that individuals associated with the project and/or task interact with the project and its associated tasks the same way.

In situations where numerous people are involved in performing the tasks associated with the project, this type of organization may not be efficient. Furthermore, it is difficult for management to oversee the completion of tasks when organized in this traditional manner.

Therefore improved systems, methods, graphical user interfaces, and computer readable media for generating and managing projects and action plans is desired.

### SUMMARY

Systems, methods, graphical user interfaces, and computer readable media for generating an action plan for a user are provided. The action plan may include, for example, an action item and/or a delegated action item. In one embodiment, an application for generating the action plan may be opened. An instruction to generate the action item may be received from, for example, a first user. An action item may related to an action to be performed and may be modified by, for example, a user. Information relating to the action item may be received from, for example, the first user. An action item may be generated using, for example, the received information. Instructions, may be received from, for example, a first user, to delegate the action item to a second user. The action item to be delegated may then be sent to, for example, the second user via, for example, email. The second user may be, for example, a contact of a first user. An application for generating the action plan may then be opened by, for example, the second user. The second user may then receive and accept the delegated action item.

In some embodiments, a user may modify the delegated action item. The modification may include, for example, repositioning the delegated action item within a display, categorizing the delegated action item, editing the delegated action item, and/or prioritizing the delegated action item.

On some occasions, the action item and/or the delegated action item may include, for example, an identification, fixed, and/or adjustable parameter. In one embodiment, a message, such as a follow-up message, related to the delegated action item may be sent. Exemplary messages include a nag message and an appreciation message.

In some embodiments the action plan may include a project. The contents of a project may be personalized to a user. The project may be generated by, for example, a user, or may be supplied by default. The project may be, for example, accessed by, for example, a first and/or second users. The action item and/or the delegated action item may be, for example, associated with the project by, for example, the first and/or second users.

In one embodiment, the action plan may include a plurality of action items and delegated action items. The plurality of action items and/or delegated action items may be prioritized by, for example, changing their relative locations on a display and/or changing their color.

On some occasions, a status may be associated with an action item and/or a delegated action item. The status may be updated. In one embodiment, the action item and/or the delegated action item and/or its status may be displayed on, for example, an activity list.

In embodiments that include a plurality of action items and/or delegated action items, the action items and/or delegated action items may be sorted according to, for example, a criteria and displayed. In another embodiment, information regarding an action item and/or a delegated action item may be shared via, for example, a feed.

In some embodiments, an action plan may include a reference item, a backburner item, and/or a discussion item. An instruction to generate a reference, backburner, and/or discussion item may be received from, for example, a first and/or second user. Information regarding a reference, backburner, and/or discussion item may then be received from, for example, a first and/or second user. A reference, backburner, and/or discussion item may then be generated using the received information and may then be displayed to, for example, a first and/or second user. A reference, backburner, and/or discussion item may be shared with, for example, another user via, for example, a feed, activity list, project list, and/or a discussion board.

Exemplary reference items include a file, a document, an attachment, a note, and a link. Exemplary backburner items may relate to, for example, a task to be performed in the distant future.

Systems, methods, graphical user interfaces, and computer readable media for managing an action plan for a user are also provided. In one embodiment, an application for managing the action plan may be opened by, for example, a user and the status of an item included in the action plan may be tracked. The item may be, in some instances, delegated to another user. The item may be, for example, an action item, a backburner item, a reference item and/or a discussion item

In some embodiments, a message may be sent to, for example, the receiving user regarding the item. Exemplary messages include a nag message and an appreciation message. In one embodiment, a status is associated with the item and its status may be displayed on, for example, a project list, an activity list, and/or a page displaying a portion of the action plan. In some embodiments, a status may be associated with an item and/or a message regarding the status may be received. The status of the item may include, for example, the current status of the item, a change in the status of the item, when the status changes, when the item is delegated, when the item is accepted, when the item is complete, who completed the item, and/or the status of a related item. The status of the item may be tracked.

In some embodiments, the action plan may include a project and the item may be assigned by, for example, a user, to the project. In one embodiment, a plurality of users may contribute to the project and the name of a project may be specific to a user such that the item is in a first project for one user and a second project for another user. In some embodiments, the item may be opened and revised.

Systems, methods, graphical user interfaces, and computer readable media for managing an action plan, wherein the action plan includes a project, are also provided. The project may include, for example, an action item, a backburner item, a reference item and/or a discussion item An application for managing the action plan may be opened, a selection of a project may be received, and the status of the project may be tracked. In one embodiment, an item may be associated with a project and the status of the item may be tracked. The tracking may include updating the status of the project and/or item. In one embodiment, the status of the project may be displayed on, for example, a project list, an activity list, or a page displaying a portion of the action plan. A message regarding the status of the item may be, for example, sent to and/or received by, for example, the user. In another embodiment, a plurality of users may contribute to the project and the name of a project may be specific to a user. The status of the project may include, for example, the current status of the project, a change in the status of the project, when the status changes, when the status of an item within the project changes and/or the status of a related project.

In one embodiment, the item may be delegated to another user and a message may be sent to the other user regarding the item. The message may be, for example, a nag message or an appreciation message.

Systems, methods, graphical user interfaces, and computer readable media for generating an action plan, wherein the action plan includes an action item, are also provided. The action plan may also include, for example, a reference item, a backburner item, and/or a discussion item An application for generating the action plan may be opened. An instruction to generate the action item may be received from, for example, a user. Information relating to the action item may be received from, for example, the user, wherein the information received from the user may include at least one of a fixed and adjustable parameter. Information relating to the action item may be received from, for example, the application, wherein the information received from the application may include an identification parameter. The action item may be generated using, for example, the received information. The generated action item may then be displayed to the user.

In one embodiment, a unique identifier for the action item may be generated using, for example, an identification parameter and a unique identifier may be associated with the action item. In some cases, the fixed parameter may be adjustable by, for example, an authorized user and an adjustable parameter may be adjustable by, for example, any user.

In one embodiment, the action item may be tracked via, for example, a identification parameter and/or a unique identifier. The tracking may include, for example, updating the status of the action item and displaying the status to the user.

In cases where the action item includes a structured element, the information received from the user may be associated with the structured element. In cases where the action item includes an unstructured element, the information received from the user may be associated with the unstructured element.

In one embodiment, instructions to delegate the action item to another user may be received and the delegated action item may be sent to another user. In another embodiment, a notification from the other user may be received regarding whether they accepted the delegated action item. In yet another embodiment the action item may be delegated to a contact of the user and may be sent via, for example, email.

In some cases, a follow-up message related to the delegated action item may be sent to, for example, a user. In yet another embodiment, the accepted action item may be linked to the delegated action item so that a change in the status of the action plan for the delegated action item may be displayed along with the accepted action item.

In a further embodiment, a project within the action plan may be generated. An action item may be associated with the project and in some cases, the project may be personalized to the user.

In embodiments wherein the action plan includes a plurality of action items, action items may be prioritized by, for example, changing their relative locations on a display or their color.

In one embodiment, a fixed and/or adjustable parameter of the action item may be revised or modified. In yet another embodiment, the action item may be displayed on, for example, an activity list. In embodiments wherein the action plan includes a plurality of action items, the action items may be sorted according to, for example, a criteria and the sorted action items may be displayed. In some cases, the action item may be shared with another user via, for example, a feed.

In some embodiments, an action plan may include a reference item, a backburner item, and/or a discussion item. An instruction to generate a reference, backburner, and/or discussion item may be received from, for example, the first and/or second user. Information regarding a reference, backburner, and/or discussion item may then be received from, for example, the first and/or second user. A reference, backburner, and/or discussion item may then be generated using the received information and may then be displayed to, for example, a first and/or second user. A reference, backburner, and/or discussion item may be shared with, for example, another user via, for example, a feed, activity list, project list, or a discussion board.

Exemplary reference items include a file, a document, an attachment, a note, and a link. Exemplary backburner items may relate to, for example, a task to be performed in the distant future.

Systems, methods, graphical user interfaces, and computer readable media for managing an action plan for a user are also provided. In one embodiment, an application for managing the action plan may be opened by, for example, a user and the status of an item included in the action plan may be tracked. The item may be, in some instances, delegated to another user. The item may be, for example, an action item, a backburner item, a reference item and/or a discussion item

Systems, methods, graphical user interfaces, and computer readable media for managing an action plan, wherein the action plan includes an action item are provided. The action item may be associated with, for example, a first project by a first user, wherein the action item may include, for example, an identification parameter and/or a unique identifier. Instructions may be received from, for example, a first user, to delegate the action item to a second user. The delegated action item may be sent to the second user. The delegated action item may be linked to the action item via, for example, the identification parameter and/or the unique identifier. The delegated action item may be associated with, for example, a second project by, for example, the second user. The action item and/or the delegated action item may be tracked by, for example, the first and/or second user via, for example, an identification parameter and/or a unique identifier.

In some embodiments, tracking the status of the action item may include updating the status of the action item. In yet another embodiment, the action item and its status may be displayed on, for example, a project list, an activity list, and/or a page displaying a portion of the action plan. The tracking may also include receiving a message regarding the status of the item. The status of the item may include, for example, the current status of the item, a change in the status of the item, when the status changes, when the item is delegated, when the item is accepted, when the item is complete, who completed the item, and the status of a related item.

In another embodiment, a message may be sent by, for example, a first user, to, for example, a second user regarding the item. The message may be, for example, a nag message and/or an appreciation message. In some embodiments, the contents of the first and second projects may be, for example, specific to the first and second users, respectively.

In another embodiment, systems, methods, graphical user interfaces for managing an action plan, wherein the action plan includes an item, for a user are provided. An application for managing the action plan may be opened. The status of an item included in the action plan may then be tracked.

In another embodiment, systems, methods, graphical user interfaces for managing an action plan, wherein the action plan includes a project are provided. An application for managing the action plan may be opened. A selection of a project may be received. The status of the project may then be tracked.

### BRIEF DESCRIPTION OF THE DRAWINGS

The present invention is illustrated by way of example, and not limitation, in the figures of the accompanying drawings, in which:

FIG. 1 illustrates a block diagram of a system 100 for generating and/or managing an action plan for a user, consistent with an embodiment of the present application;

FIG. 2 illustrates an exemplary GUI 200 enabled to generate and/or manage an action plan for a user, consistent with an embodiment of the present application;

FIG. 3A-E illustrate exemplary features and functions associated with adding a new action item, consistent with an embodiment of the present application;

FIGS. 4A-4H illustrate exemplary features and functions associated with a menu display, consistent with an embodiment of the present application;

FIGS. 5A-H illustrate exemplary features and functions associated with a reference icon, consistent with an embodiment of the present application;

FIGS. 6A-E illustrate exemplary features and functions associated with a backburner icon, consistent with an embodiment of the present application;

FIGS. 7A-D illustrate exemplary features and functions associated with a discussion icon, consistent with an embodiment of the present application;

FIGS. 8A-8B illustrate exemplary features and functions associated with a project view icon, consistent with an embodiment of the present application;

FIG. 9 illustrates exemplary features and functions associated with a resources icon, consistent with an embodiment of the present application;

FIG. 10 illustrates an exemplary process of generating an action item, consistent with an embodiment of the present application;

FIG. 11 illustrates an exemplary process of delegating an action item, consistent with an embodiment of the present application;

FIG. 12 illustrates an exemplary process of generating a project, consistent with an embodiment of the present application;

FIG. 13 illustrates an exemplary process of generating a reference item, consistent with an embodiment of the present application;

FIG. 14 illustrates an exemplary process of generating a discussion item, consistent with an embodiment of the present application;

FIG. 15 illustrates an exemplary process of generating a backburner item, consistent with an embodiment of the present application;

FIG. 16 illustrates an exemplary process of managing an action plan, consistent with an embodiment of the present application;

FIG. 17 illustrates an exemplary process of managing an action plan, consistent with an embodiment of the present application; and

FIG. 18 illustrates an exemplary process of managing an action plan, consistent with an embodiment of the present application.

### DETAILED DESCRIPTION

Methods, systems, graphical user interfaces (GUI), and computer readable media for generating an action plan for a user are provided. An action plan may include one or more items relating to the plan. Exemplary items include an action item, a reference item, a discussion item, and/or a backburner item.

An action item may relate to, for example, a task to be completed in the future, typically the near future, by, for example, a user or someone to whom the user delegates the action item. Action items may be delegated to, for example, a contact of a user. A contact of a user may be, for example, another user or person known by the user. A contact may be displayed as, for example, a name or an email address. Action items may be edited and may be checked off when complete. An action item may also include information regarding who delegated the action item to a user and/or to whom the user delegated the action item. Action items may be associated with, for example, a project and/or action plan.

An action item may include, for example one or more identification parameters, fixed parameters, and adjustable parameters. Identification parameters may serve as a unique identifier for an action item and/or may serve to identify the action item to, for example, an application for generating and/or managing an action plan, or a user. Identification parameters may be assigned by, for example, an application for generating and/or managing an action plan, and may, for example, be hidden from a user. Once assigned, an identification parameter may remain unchanged throughout the lifetime of an action item.

Identification parameters may be used to, for example, track an action item, link the action item to, for example, a project, a user, and/or a group of users, and/or link an action item that may be delegated to and/or shared between two or more users such that, for example, the status of the action item is tracked. Tracking the action item may be done via, for example, one or more feedback loops.

A fixed parameter may be a parameter associated with an action item by, for example, a user and/or an application for generating and/or managing an action plan. A fixed parameter may, for example, remained fixed and may not be adjustable, or may be adjustable only in certain circumstances and/or be an authorized user. Exemplary fixed parameters include a due date for an action item, the content of an action item, and/or a priority level for an action item. In the example of a due date for an action item, a due date may be associated with the action item by, for example, a user upon, for example, generation or delegation of the action item. When the user delegates and/or shares the action item with another user, or group of users, the due date may be fixed so that, for example, only authorized users, such as the user who delegated the action item, may adjust the due date parameter. Fixed parameters may be tracked and may be the same for one or more users.

An adjustable parameter may be a parameter associated with an action item by, for example, a user and/or an application for generating and/or managing an action plan. An adjustable parameter may, for example, be adjusted by a user at any time. Exemplary adjustable parameters include the color of an action item, its placement in a GUI, is association with a project, and its priority within for example, a project or an action plan. Adjustable parameters may not be tracked and may be specific to an individual user.

An action item may include a structured and an unstructured element. Both structured and unstructured elements may relate to one or more of an identification parameter, a fixed parameter, and/or an adjustable parameter. A structured element may be an element common to one or more action items and may include, for example, a checkbox or selection option. An exemplary checkbox may be displayed and its selection may indicate, for example, that an action item is complete. An unstructured element may be specific to, for example, an action item, a project, or a user. An unstructured element may be, for example, the text of an action item.

A backburner item may relate to a task to be completed in the distant future, for example, two months or a year from now. Backburner items may be associated with, for example, a project and/or action plan.

A reference item is an item that may relate to, for example, an action item, project, and/or action plan. Exemplary reference items include notes, links, files, documents or other attachments associated with an action item and/or project. Reference items may be shared with other users. Reference items may be associated with, for example, a project and/or action plan.

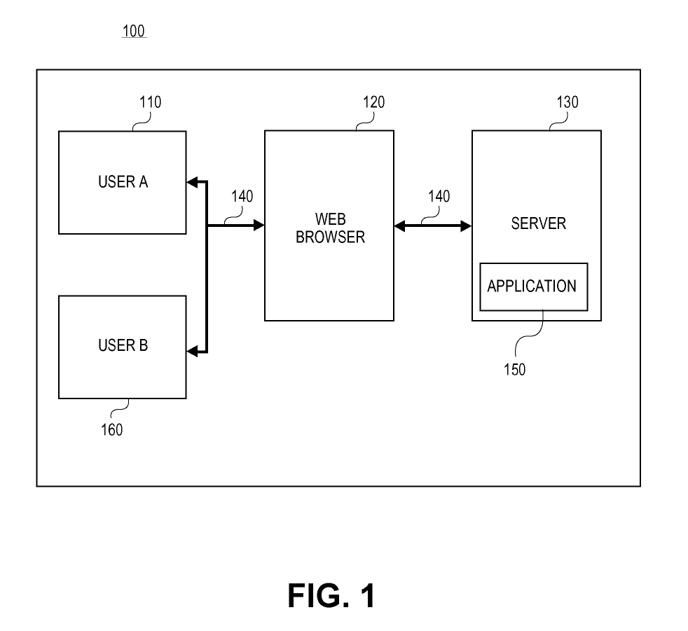

FIG. 1 illustrates a block diagram of a system 100 for generating and/or managing an action plan for a user. System 100 includes a user A 110, a web browser 120, a server 130 and communication links 140. System 100 also includes an application 150 enabled to generate an action plan for a user, for example user A 110. Application 150 may be resident in, for example, server 130. User A 110 may access application via, for example, web browser 120. Application 150 may generate one or more GUIs to enable a user, for example, user A 110, to generate an action plan, or a portion thereof. A generated GUI may display icons that may link a graphic displayed on the GUI to, for example, content, another GUI, and/or menu item. Some icons displayed may be specific to a GUI, while others may be displayed on multiple or all generated GUIs. Communication links 140 may be any appropriate communication link between user A 110, web browser 120 and server 130, including wired or wireless communication links.

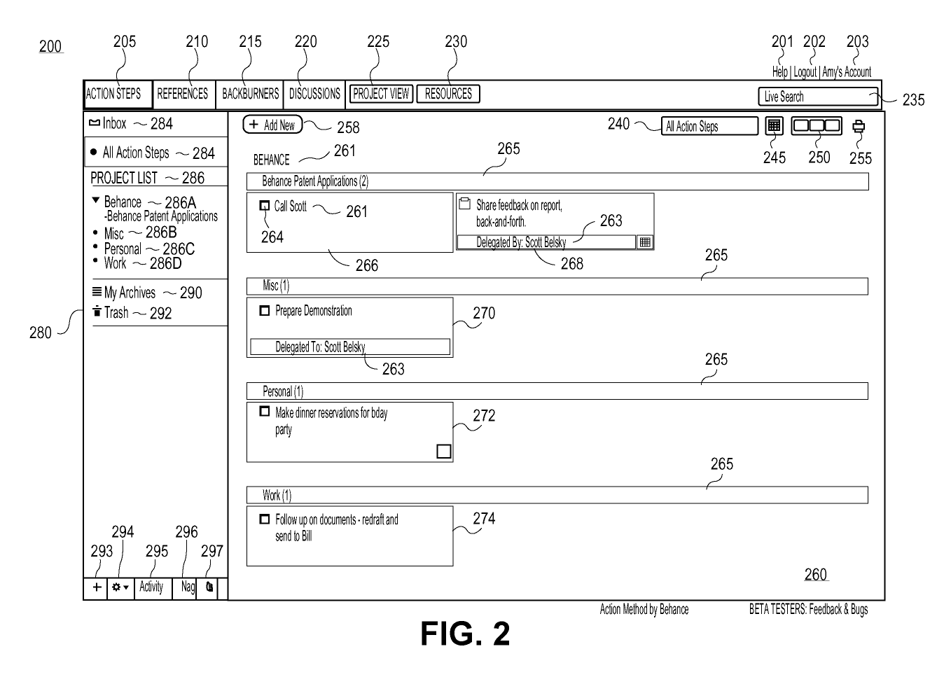

FIG. 2 illustrates an exemplary GUI 200 enabled to generate and/or manage an action plan for a user. GUI 200 may be generated by, for example, application 150. GUI 200 may include any number of icons, which, when selected or “clicked” on may initiate the display of a subsequent, related GUI, GUI object(s) and/or menu item(s). A GUI object may be, for example, a window displayed within a GUI. GUI 200 may include a help icon 201, a logout icon 202, and a user's account icon 203. Help icon 201, logout icon 202, and/or user's account icon 203 may be displayed on other GUIs as well.

Selection of help icon 201 may initiate the display of a help GUI that may assist a user with the GUI, a component of the GUI, or with an application that generates GUI 200, such as application 150. Selection of logout icon 202 may initiate a logout sequence for a user to log out of an application that generates GUI 200, such as application 150. Selection of user's account icon 203 may initiate a display of a one or more items related to a user's account. Exemplary items may include a user's address book or preferences. Items displayed following selection of user's account icon 203 may be interactive, or otherwise.

GUI 200 may further include, for example, an action items icon 205, a references icon 210, a backburner icon 215, a discussions icon 220, a project view icon 225, and/or a resources icon 230. Selection of icons 205-230 may initiate the display of a GUI related to the icon. For example, selection of action items icon 205, may initiate display of an GUI related to action, like GUI. Likewise, selection of discussions icon 220 may initiate display of a GUI related to discussion items, et cetera.

GUI 200 may include an action item display window 260. Action item display window 260 may include one or more project icons 265. Selection of a project icon 265 may expand and/or collapse a display of an action item(s) related to, for example, a project. Exemplary action items displayed when a project icon 265 is expanded, include, for example, action items 266, 268, 270, 272, and 274. An action item may include, for example, text relating to the action item 261, a status bar 263, and/or a check box 264.

Status bar 263 may indicate the status of an action item. Exemplary statuses include delegated to, delegated by, and awaiting. A status of delegated to may indicate that the action item has been delegated to another user. Upon receipt by the other user of a delegated action item, the other user may accept and/or reject the action item. Prior to acceptance or rejection by the other user, the status of the action item may be displayed as awaiting. When an action item has been delegated to a user, such as user A 110, the status of the action item may be displayed as delegated by . . . (name of delegator) as in action item 268. Check box 264 may be selected when, for example, a user, such as user A 110, competes the action related to the action item. Following selection of check box 264, an action item, such as action items 266-274 may be removed from action item display window 260 or may be displayed on GUI 200 as completed.

Action items 266-274 may be rearranged in action item display window 260. An action item may be selected and dragged to a new location within action item display window 260, either within the same project, or within a new project. Such rearrangement may be performed in order to, for example, prioritize action items. For example, a user, such as user A 110, may rearrange displayed action items such that the highest priority action items are displayed first. A user may also select an action item and drag it into a project listed in, for example, project list 286, after which the action item may be associated with the project.

A user, such as user A 110, may select the type of action items to be displayed on action item display window 260. Such a selection may be accomplished via, for example, an all action steps icon 240 and/or all action steps icon 284. Selection of icon 240 and/or icon 284 may initiate the display a list of, for example, projects, to which action steps or items are related and may enable a user to select from the list of action items. In some cases, when a user may select a project only action items related to the selected project may be displayed.

GUI 200 may further include a calendar icon 245, a color selection icon 250, and a printing icon 255. Selection of calendar icon 245 may display a calendar. Color selection icon 250 may include one or more colors that may be selected for an action item. For example, the color selected for action item 266 is blue, while the color selected for action item 268 is orange. Printing icon 255 may enable a user to conveniently print one or more items displayed on or related to GUI 200.

Menu display 280 may be displayed in any GUI related to, for example, action items icon 205, a references icon 210, a backburner icon 215 a discussions icon 220, a project view icon 225. Menu display 280 may include, for example, an inbox icon 284, an all action items icon 284, project list icons 286A-D, a my archive icon 290, a trash icon 292, an add project icon 293, a options icon 294, an activity icon 295, a nag icon 296, and an appreciation icon 297.

Inbox icon 282 may be displayed in menu display 280. Inbox icon may serve a link for a user, such as user A 110, to his or her inbox. Exemplary contents of an inbox include action items delegated to a user, such as user A 110. Inbox icon 282 may indicate when a new and/or unviewed item has been added to a user's inbox. For example, inbox icon 282 may be displayed in two colors, one for when no new items are included in an inbox, and another for when a new item is included in an inbox. In another example, inbox icon 282 may display the number of new and/or unviewed items in a user's inbox.

Project list icons 286A-D may be, for example, listed under a project list that may be displayed in, for example, menu display 280. Any of project icons 286A-D may be expanded to show sub-projects included within a project. An example of such an expanded display is shown in project list icon 286A. A project list icon may include, for example, projects supplied by default, such as “personal” or “miscellaneous.” A project list may also include projects created by a user, such as user A 110, such as “Behance” and sub-projects such as “Behance Patent Applications.”

GUI 200 may also include a my archive icon 290, a trash icon 292, an add project icon 293, an options icon 294, an activity icon 295, a nag icon 296, and/or an appreciation icon 297. Selection of my achieve icon 290 may allow a user to access archived information, for example, archived action items, backburner items, reference items, and/or discussion items. An item, for example, an action item, may be moved to trash icon 292 to remove it from, for example, a project and/or GUI.

Add project icon 293 may be used to add a project to an action plan. A new project may be displayed, for example, in menu display 280. The added project may be displayed under, for example, the project list.

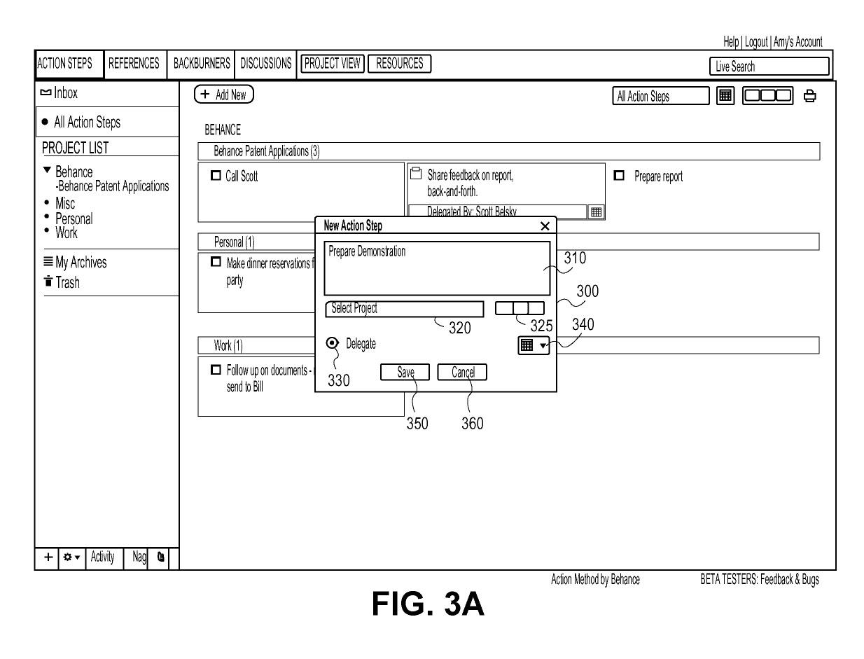

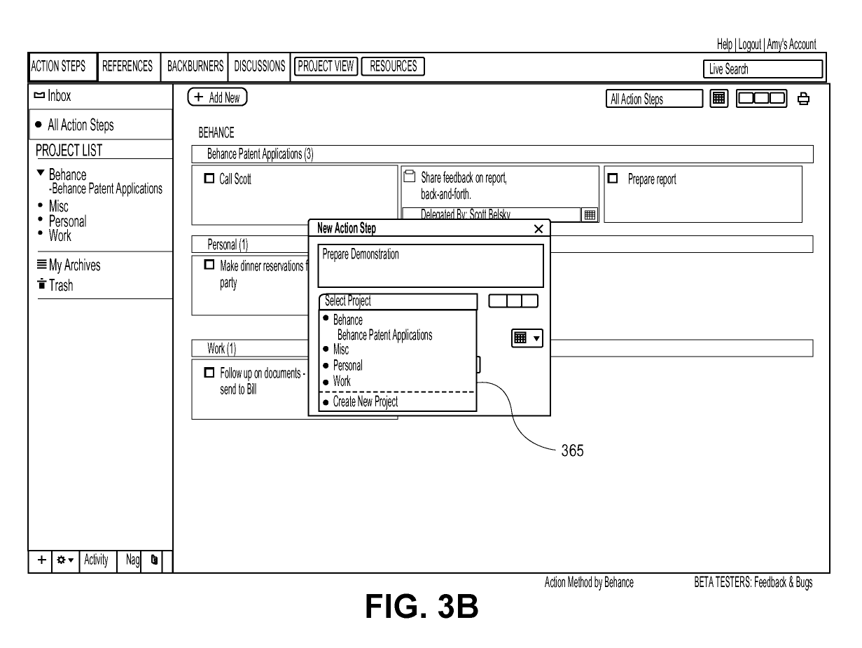

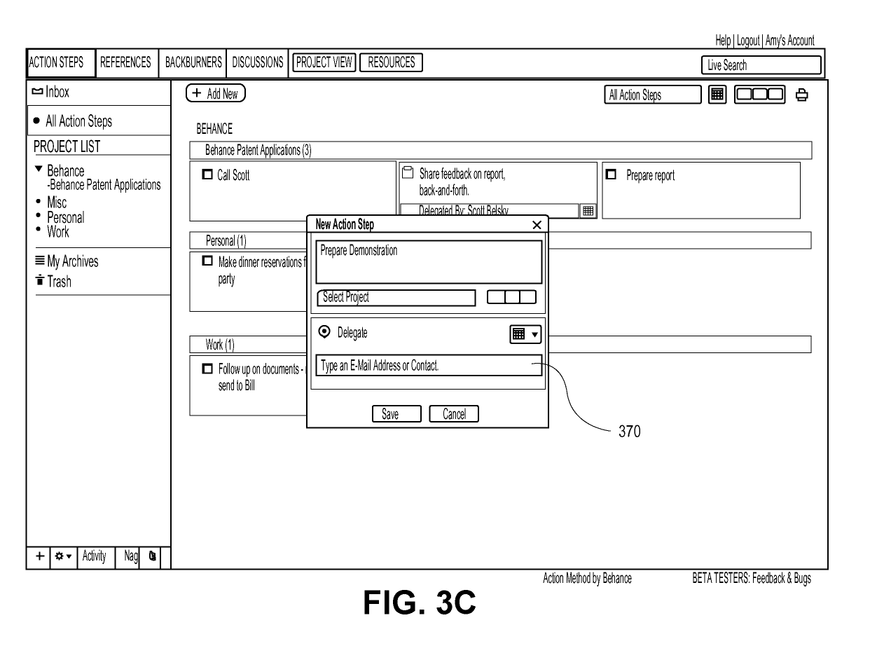

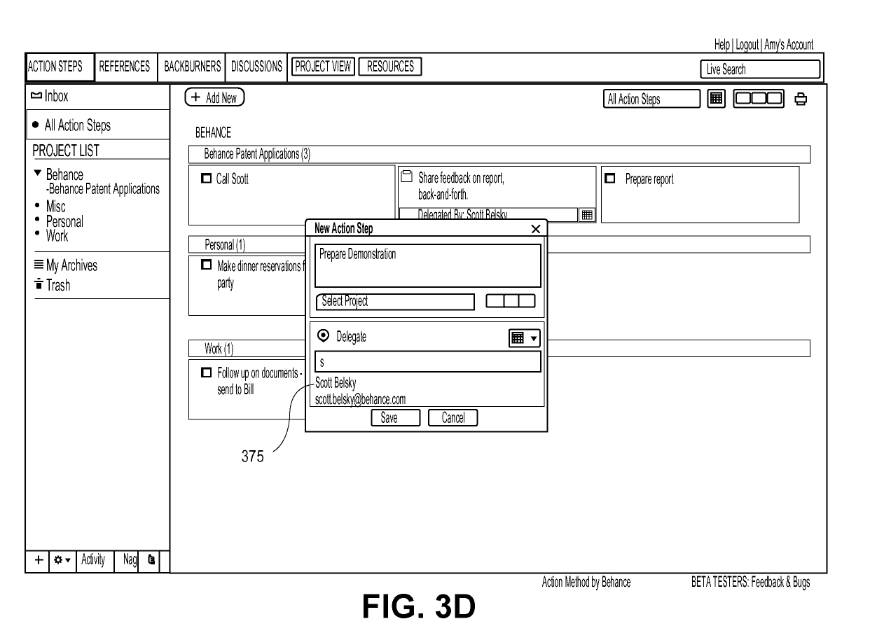

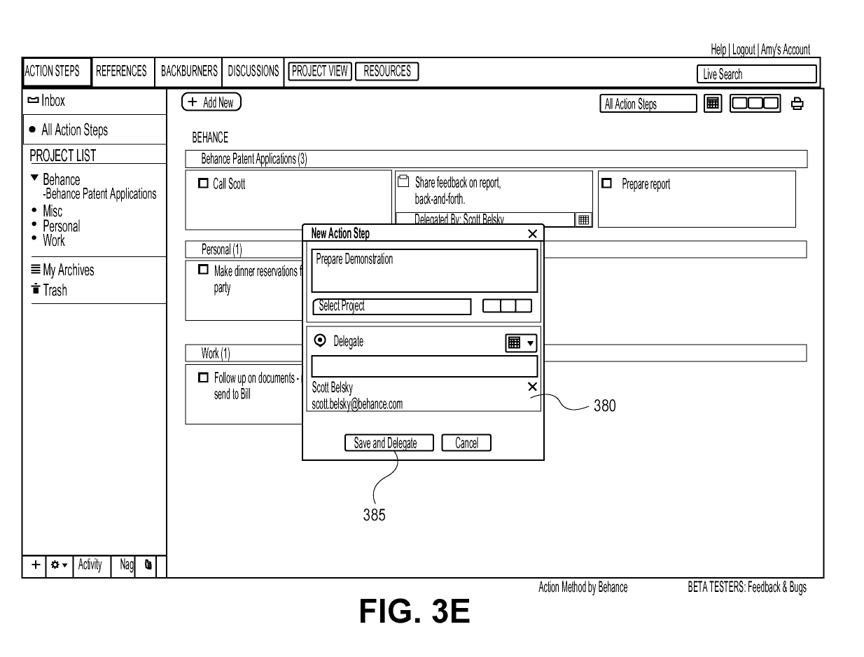

FIG. 3A illustrates a new action item GUI object or window 300 for adding a new action item. GUI object 300 may include, for example, a text box 310, a select project icon 320, a color selection icon 325, a delegation icon 330, a calendar icon 340, a save icon 350, and/or a cancel icon 360. Text box 310 may accept text entered by a user. The entered text may, for example, be related to an action item, for example, “Prepare Demonstration.” Color selection icon 325 may be used to select the color of the action item. Exemplary colors include blue, silver, and green. Selection of calendar icon 340 may display a calendar. Selection of save icon 350 may save the new action item and selection of cancel icon 360 may cancel the process of creating a new action item.

FIG. 3B illustrates a new action item GUI object 300 and includes a list of projects to be selected 365. List of projects 365 may correspond to the list of projects displayed on menu display 280, and may include, for example, project list icons 286A-D. A user may associate a new action item with a project displayed on list of projects 365.

FIG. 3C illustrates a new action item GUI object 300 and includes a delegation text box 370. Delegation text box 370 may be displayed upon the selection of delegation icon 330. A delegee may be entered into delegation text box 370. In some embodiments, an email address or contact name may be entered into delegation text box 370. The email address or contact name may be displayed on a list, such as a contact list 375 as shown on FIG. 3D. Upon entering and/or selecting a delegee, contact information for the delegee may be displayed in, for example, a contact text box 380 and a save and delegate icon 385 may be subsequently displayed as shown in, for example, FIG. 3E. When save and delegate icon 385 is selected, the new action item may be sent to the delegee, via, for example, email or other appropriate means. If the delegee has access to the application for generating an action plan, for example, application 150, then the new action item may appear in the delegee's inbox where the delegee can, for example, accept or reject the action item. If the delegee does not have access to the application for generating an action plan, then he/she may, for example, be prompted to access the application on, for example, a trial basis, and open the action item.

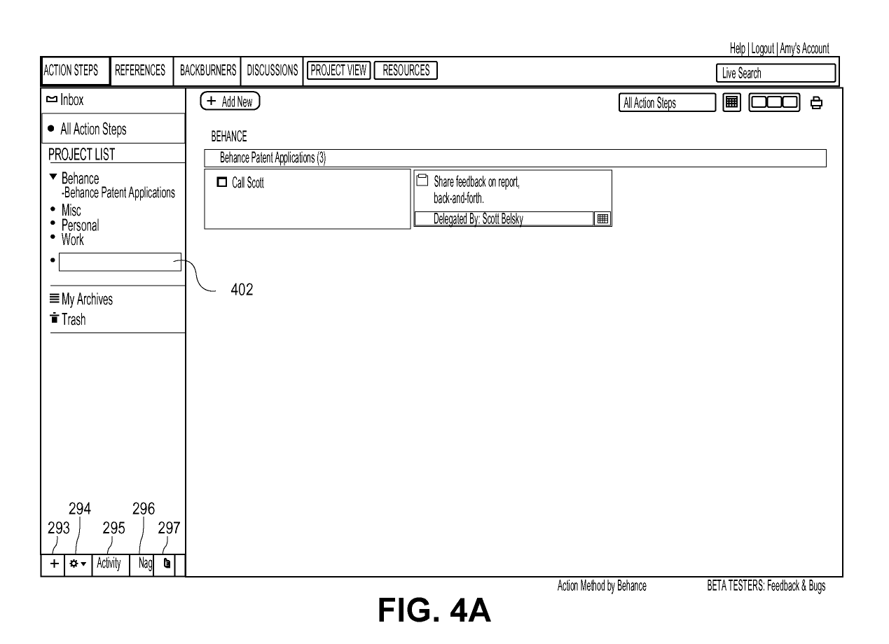

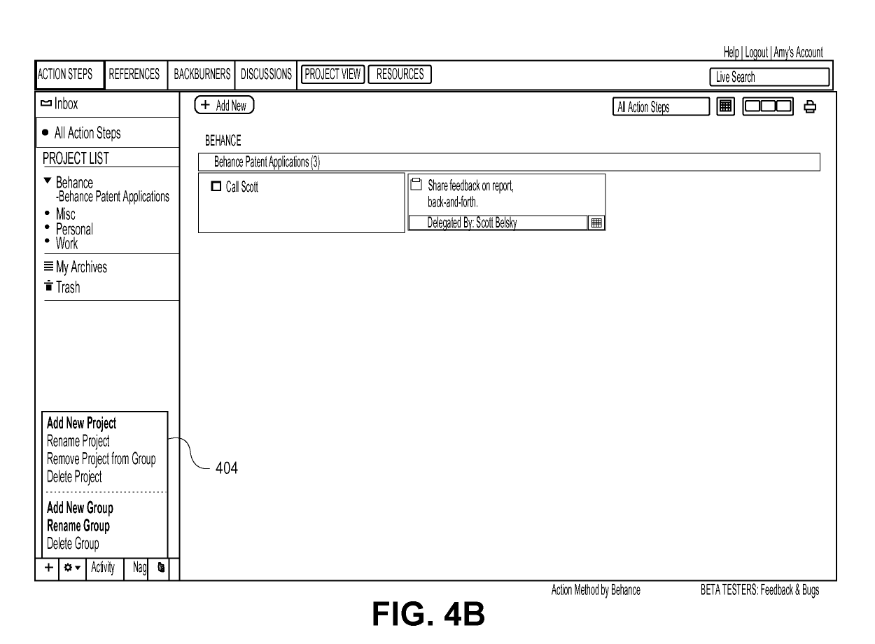

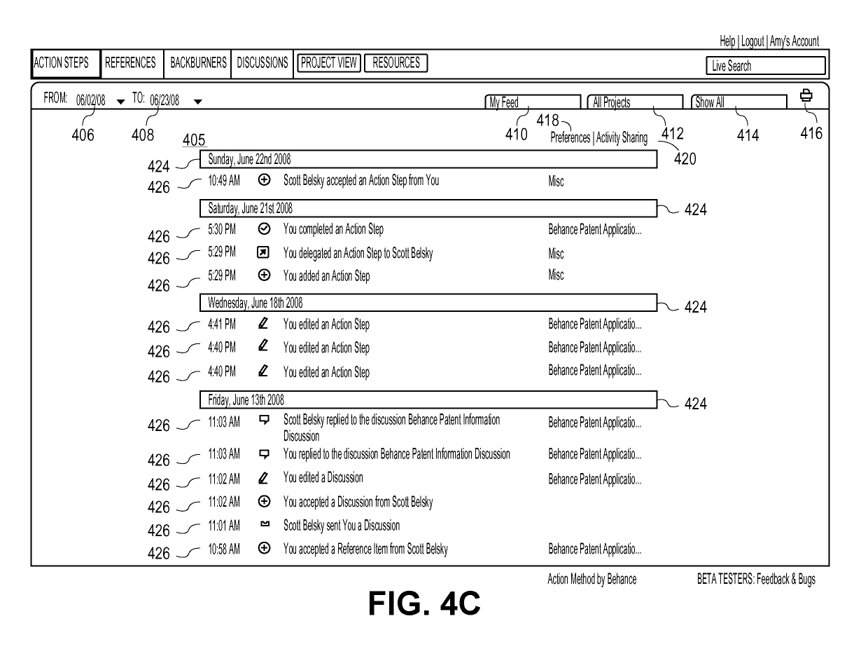

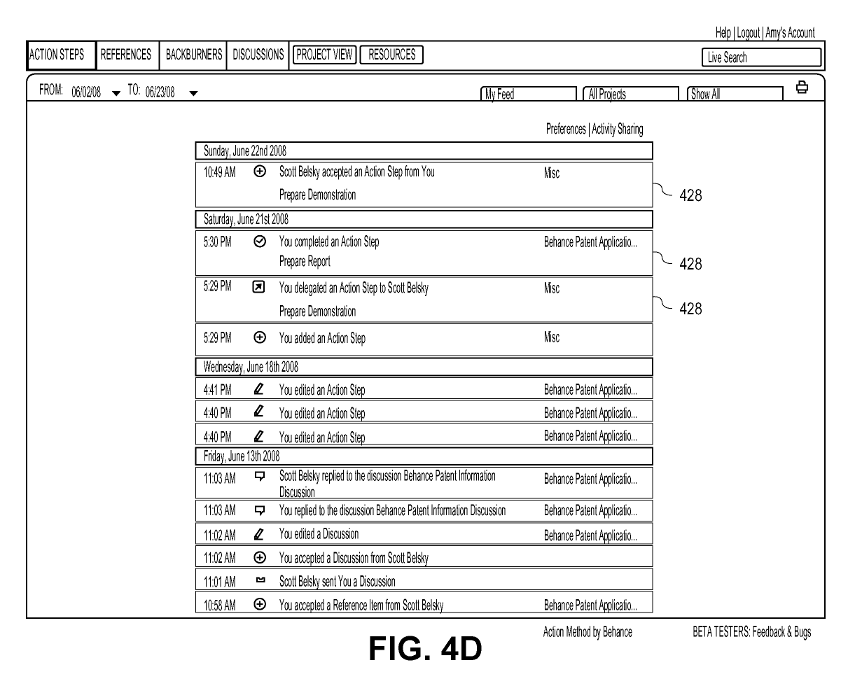

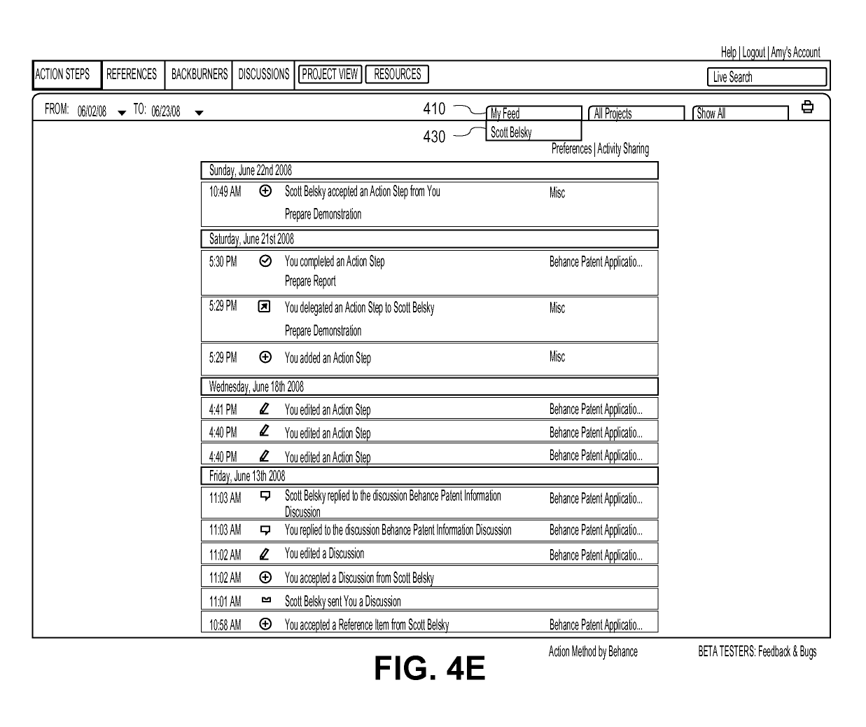

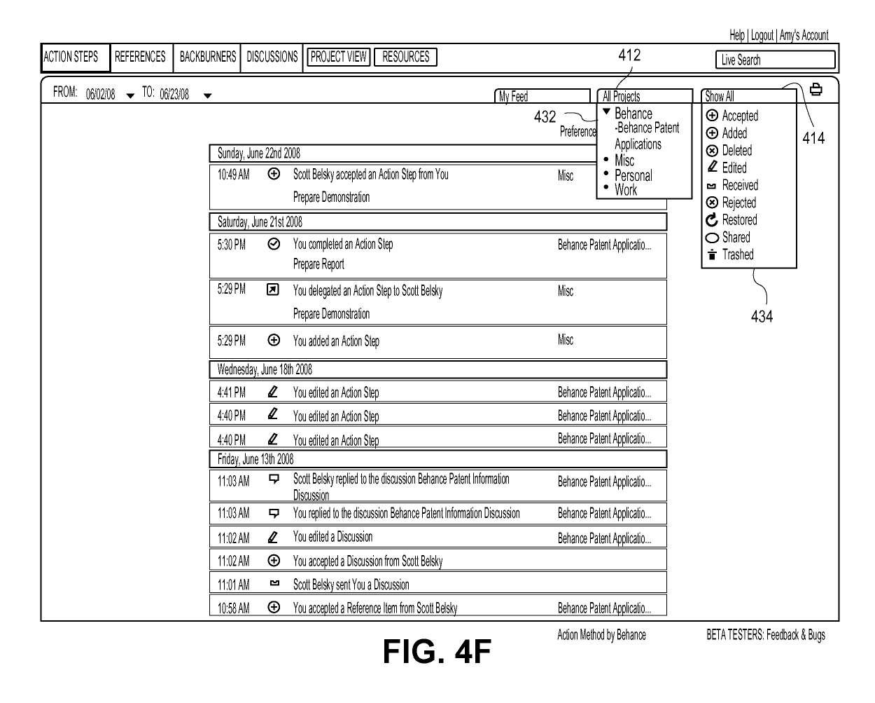

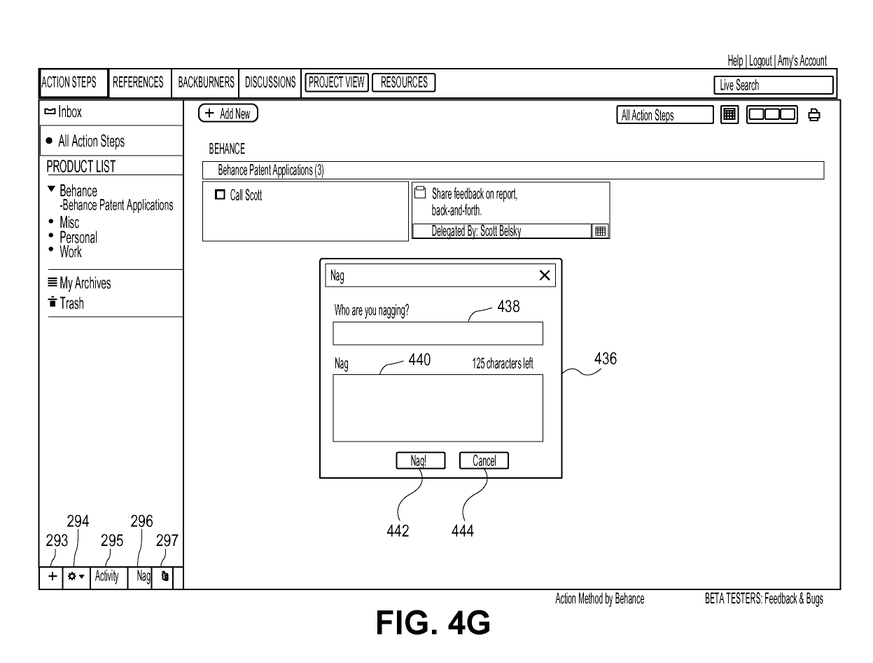

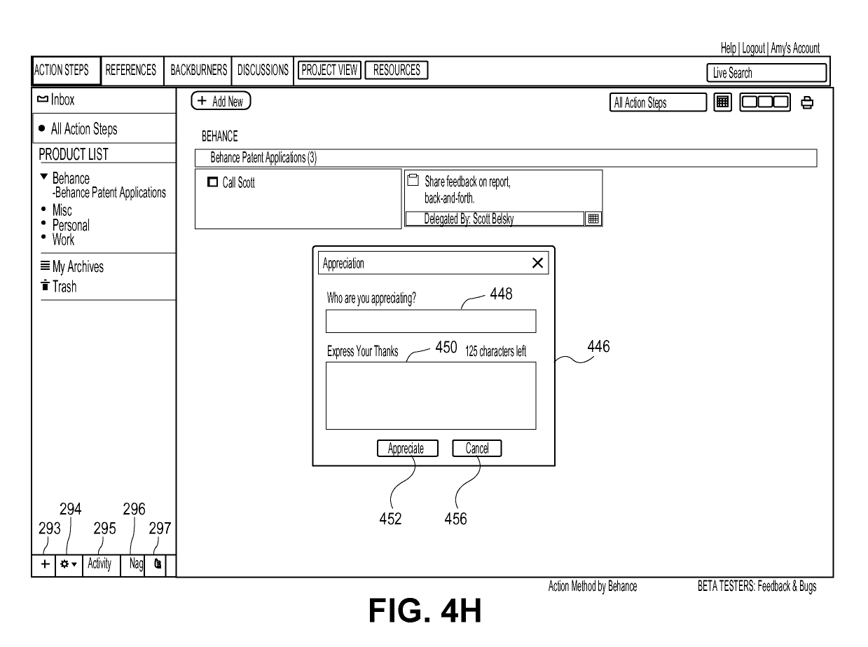

FIGS. 4A-4H illustrate exemplary features and functions associated with menu display 280. FIG. 4A displays a new project text box 402. The name for a new project and/or sub-project to be included in the project list may be entered into a new project text box, such as new project text box 402. New project text box 402 may be displayed upon the selection of new project icon 293.

FIG. 4B illustrates a menu of options 404. Menu of options 404 may include, for example, menu options related to a project or group. Menu of options 404 may be displayed upon selection of options icon 294.

FIG. 4C illustrates an activity list GUI 405. Activity list GUI 405 may be displayed upon selection of activity icon 295. Activity list GUI may include, for example, calendar icon 406 and 408, a my feed icon 410, an all project icon 412, a show all icon 414, a print icon 416, a preferences icon 418, an activity sharing icon 420, a plurality of date headers 424, and a plurality of action activity items 426.

Calendar icons 406 and 408 may be used to set a date range for the action items and/or actions displayed on action list 405. Selection of preferences icon 418 may initiate the display of, for example, one or more preferences and/or preference options. Selection of activity sharing icon 418 may initiate the display of, for example, one or more activities to be shared and/or contacts with whom activities may be shared. Date headers 424 may display the date an action took place. Action activity items 426 may include, for example, the time the activity took place, a graphic representing the type of activity that took place, a description of the activity that took place, and/or the project to which the activity belongs. Selection of an action activity item, such as action activity item 426, may expand the action activity icon into an expanded action activity icon 428, as illustrated in FIG. 4D.

FIG. 4E illustrates a feed drop down menu 430 associated with a selection of my feed icon 410. Contacts with whom a user, such as user A 110, may share a feed may be displayed in feed drop down menu 430. Selection of a contact from feed drop down menu 430 may initiate a feed of information with the selected contact.

FIG. 4F illustrates a project drop down menu 432 and a show all drop down menu 434 associated with selection of all projects icon 412 and show all icon 414, respectively. Project drop down menu 432 may display one or more projects associated with a user. The projects displayed in project drop down menu 412 may correspond to the projects shown in the project list of menu display 280. Selection of a project from project drop down menu 412 may change the displayed activity list 405 such that only activities related to the selected project are shown. Show all drop down menu 434 may include graphics associated with a type of activity, for example, accepted, added, et cetera that may relate to an action item.

FIG. 4G illustrates a nag GUI object or window 436. Selection of nag icon 296 may initiate display of nag GUI object 436. A user may send a nag to a contact in order to, for example, follow up on an action item or project with the contact nagged. Nag GUI object 436 may include a contact text box 438, a nag text box 440, a nag execution icon 442 and/or a cancel icon 444. A contact a user wishes to nag may be entered into contact text box 438. The contact may be selected from a list. A user may enter the text of the nag in nag text box 440. A user may execute the nag by selecting nag execution icon 442 and may cancel the nag by selecting cancel icon 444.

FIG. 4H illustrates an appreciation GUI object and/or window 446. Selection of appreciation icon 297 may initiate display of appreciation GUI object 446. A user may send an appreciation to a contact in order to, for example say thank you or job well done to a contact. Appreciation GUI object 446 may include a contact text box 448, an appreciation text box 450, an appreciation execution icon 452 and/or a cancel icon 456. A contact a user wishes to appreciate may be entered into contact text box 448. The contact may be selected from a list. A user may enter the text of the appreciation in appreciation text box 440. A user may execute the appreciation by selecting appreciation execution icon 452 and may cancel the appreciation by selecting cancel icon 456.

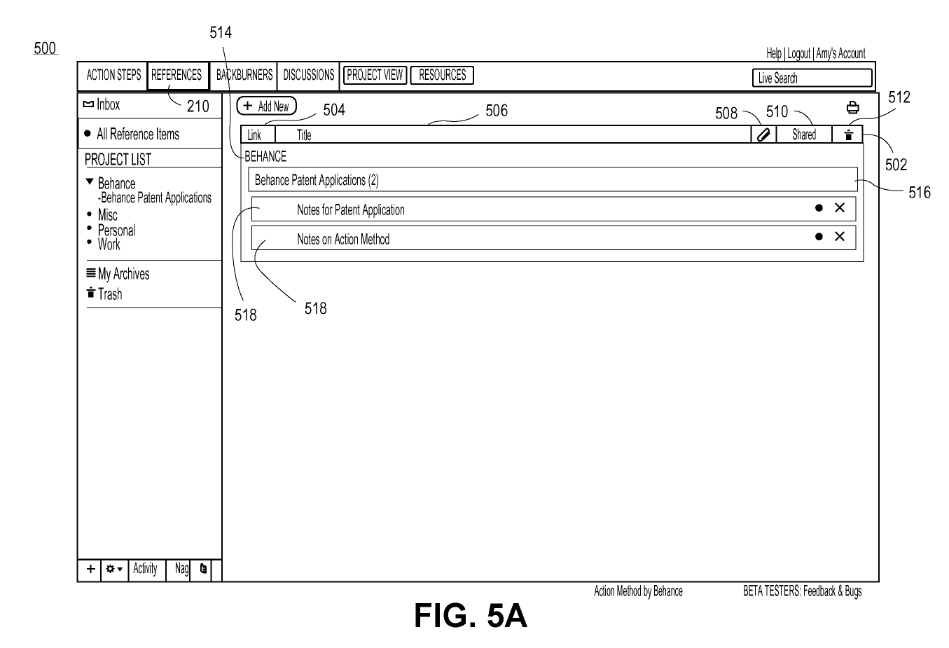

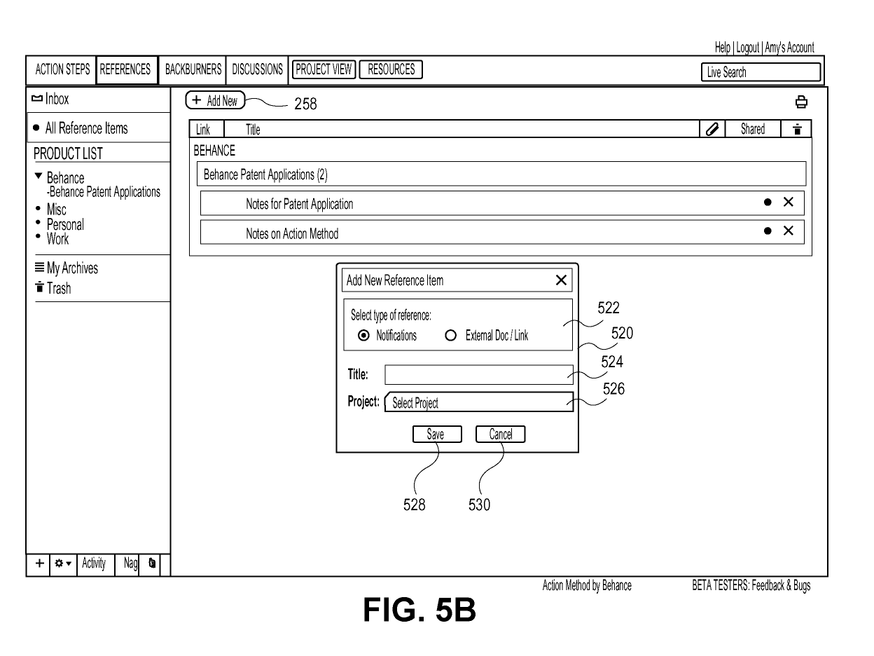

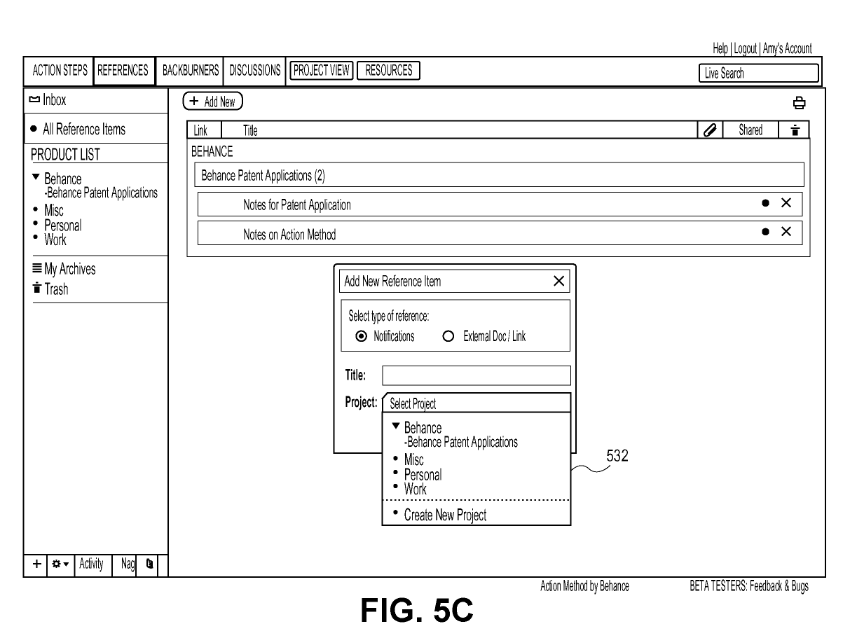

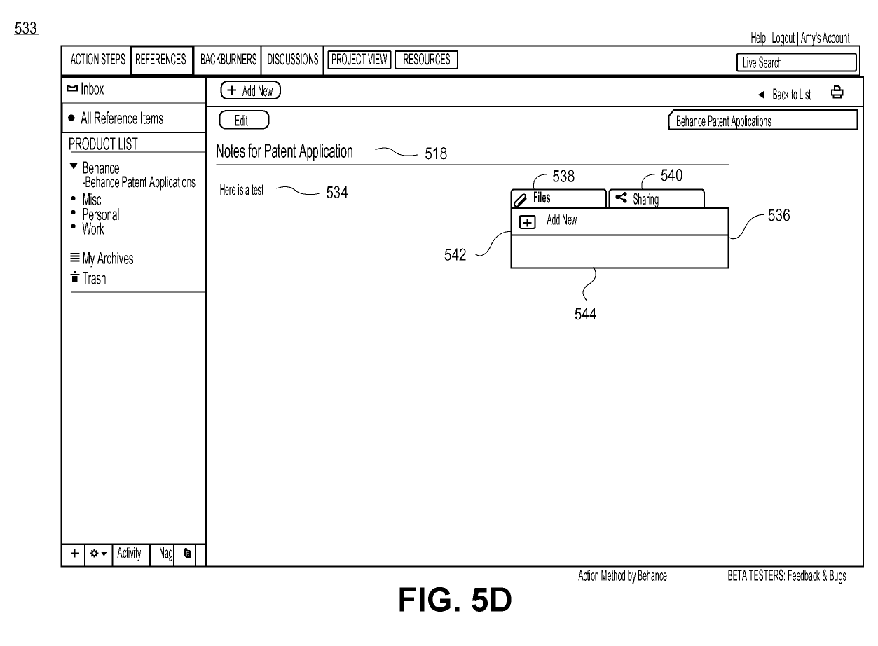

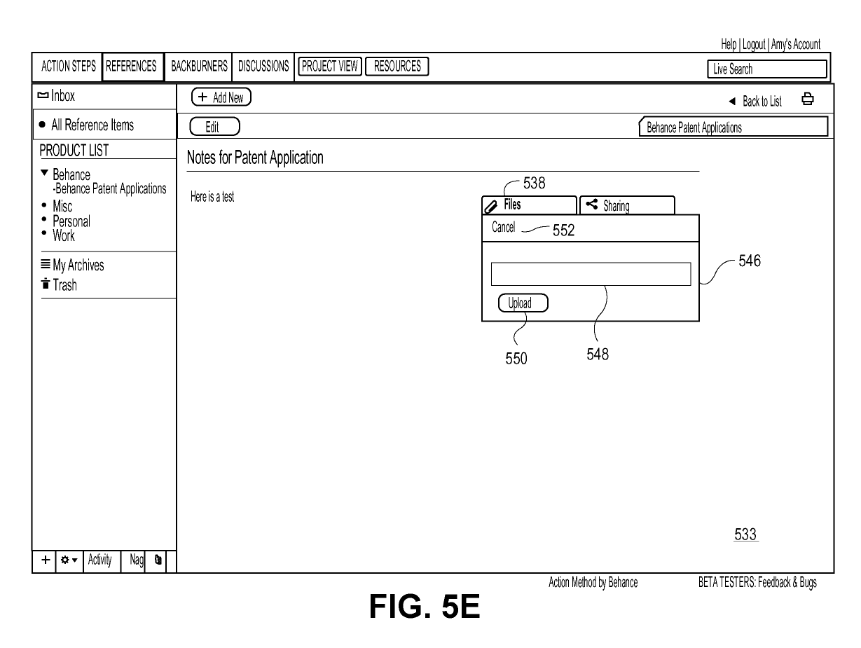

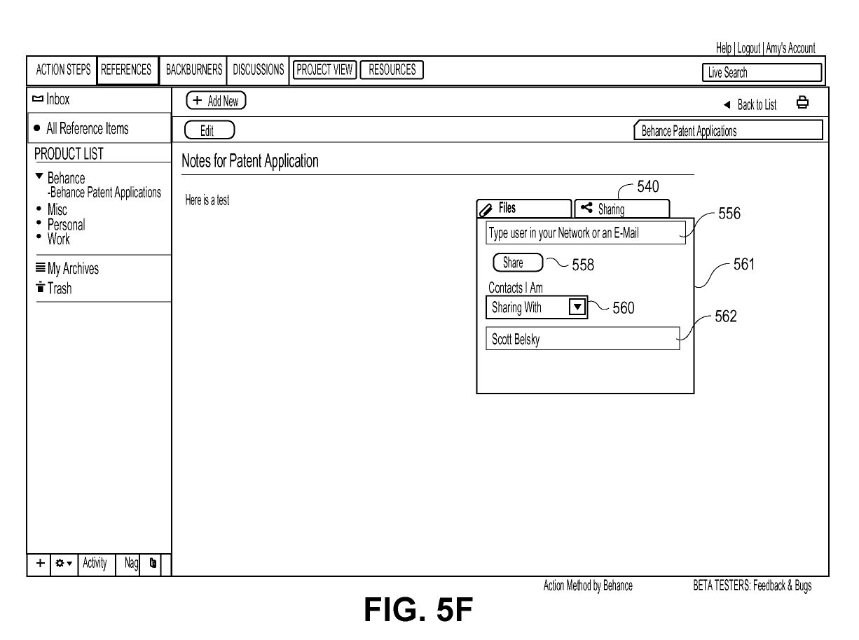

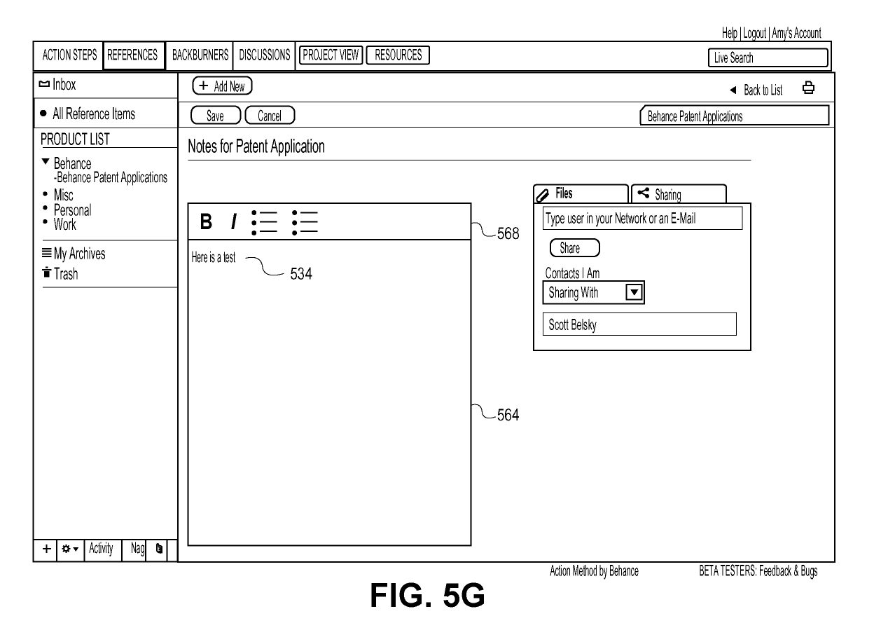

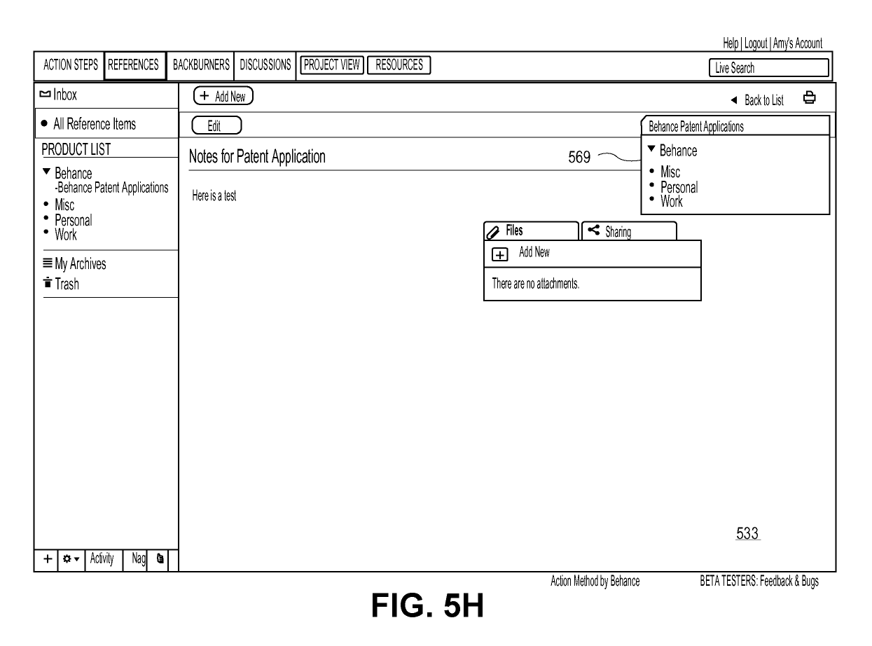

FIGS. 5A-H illustrate exemplary features and functions associated with references icon 210. FIG. 5A illustrates an exemplary references GUI 500 displayed when the references icon is selected. GUI 500 may include, for example, a heading bar 502, a project title 514, a sub-project title 516, and reference items 518. Heading bar 502 may include, for example, a link heading 504, a title heading 506, an attachment icon 508, a shared icon 510, and a trash icon 512.

Heading bar 502 may contain heading for reference items 518 included in GUI 500. Link heading 504 may provide information regarding links to and/or from one or more reference items 518. Title heading 506 may provide a heading and/or a column heading for one or more reference items 518. Selection of attachment icon 508 may enable a user, such as user A 110, to attach information, such as a document, to a reference item 518. Attachment icon 508 may also provide a column heading for attachment(s) related to a reference item 518. Selection of shared icon 510 may enable a user, such as user A 110, to share a reference item 518 with another, for example, a contact of the user. Share icon 510 may also provide a column heading for attachment(s) information related to sharing a reference item 518.

Project title 514 may be any project title of a user's, such as user A 110, action plan. In exemplary GUI 500, the Behance project is selected as the project to be displayed when references tab 210 is selected. A project may be selected from, for example, project list 286 displayed for example, in menu display 280. When a project is selected, information regarding the references and/or reference items 518 may be displayed on references GUI 500. If a project has a one or more sub-projects a project sub-title 516 may also be displayed on references GUI 500. A sub-project may be selected from, for example, project list 286, and may be displayed in for example, menu display 280.

Upon selection of add new icon 258 while references GUI 500 is displayed, an add new reference item window 520 may be displayed, as is shown in FIG. 5B. New reference item window 520 may be, for example a GUI object. Information entered into new reference item window 520 may be used to generate a new reference item 518. New reference item window 520 may include, for example, a type of reference item selection box 522, a title text box 524, a project selection menu 526, a save icon 528 and a cancel icon 530.

Type of reference item selection box 522 may include, for example, a plurality of types of reference item from which a user, such as user A 110, may select one or more reference item types. Exemplary reference item types include a notations type and an external doc/link type. Title text box 524 may be a text box, into which a user, such as user A 110, may enter a title for a new reference item 518. Selection of project selection menu 526 allows a user to associate a new reference item 518 with a project. Selection of project selection menu may display a project drop down menu 532, such as the one displayed in FIG. 5C. The projects displayed in project drop down menu 532 may correspond to the projects displayed in project list 286 as shown in, for example, display menu 280. Selection of save icon 528 may save the new reference item 518 and selection of cancel icon 530 may cancel the process of creating the new reference item 518.

FIG. 5D illustrates an exemplary reference item GUI 533 for an exemplary reference item 518. Reference item GUI 533 may include, for example, reference item contents 534 and a file/sharing GUI object 536. File/sharing GUI object 536 may include, for example, an attach file icon 538, a sharing icon 540, an add new icon 542, and a text box 544. Reference item contents 534 may include, for example, information related to a reference item 518, such as text. Selection of attach file icon 538 may enable a user to attach, for example, a file or document to reference item 518.

Selection of attach file icon 538 may initiate the display of an attach file GUI object 546, as shown in FIG. 5E. Attach file GUI object 546 may include, for example, a cancel icon 552, a text box 548, and an upload icon 550. A user may enter and/or select a file to be attached to reference item 518 into text box 548. Selection of upload icon 550 may initiate the uploading of the entered and/or selected file to reference item 518. Selection of cancel icon 552 may cancel the attachment to reference item 518.

Selection of sharing icon 540 may initiate the display of a sharing GUI object 561, as shown in FIG. 5F. Sharing GUI object 561 may include, for example, a user identification text box 556, a share icon 558, a sharing type selection menu 560 and a contact display box 562. A user may enter identifying information into user identification text box 556. Exemplary identifying information includes a user's network and/or email address. A user may select a type of sharing, for example, sharing with or awaiting answer from via a sharing type selection menu 560. A user may select a user to share with via contact display box 562. Selection of share icon 558 may, for example, initiate a sharing session between the user and a contact.

FIG. 5G illustrates a reference item editing window 564. Selection of a reference item 518 may initiate the display of reference item editing window 564. Reference item editing window 564 may include, for example, a formatting bar 568 and information related to the reference item 534. Formatting bar 568 may include icons for formatting the information included for the reference item. Exemplary icons include a icon to make text bold and a bulleting icon.

FIG. 5H illustrates a project drop down menu 569 displayed on references GUI 500. Project drop down menu 569 may display one or more projects associated with a user. The projects displayed in project drop down menu 569 may correspond to the projects shown in the project list of menu display 280. Selection of a project from project drop down menu 569 may change the displayed references GUI 500 such that only references related to the selected project are shown.

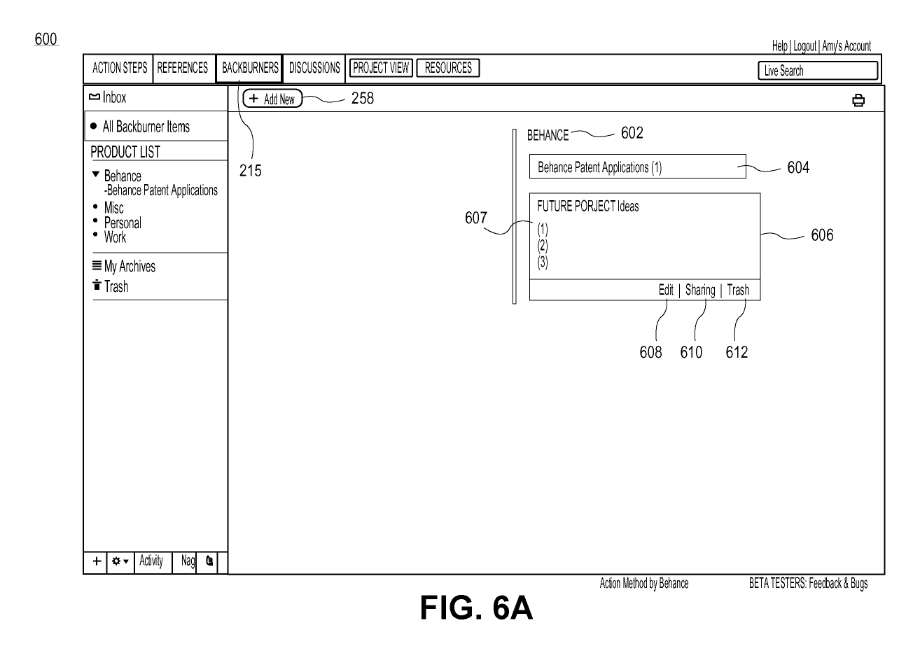

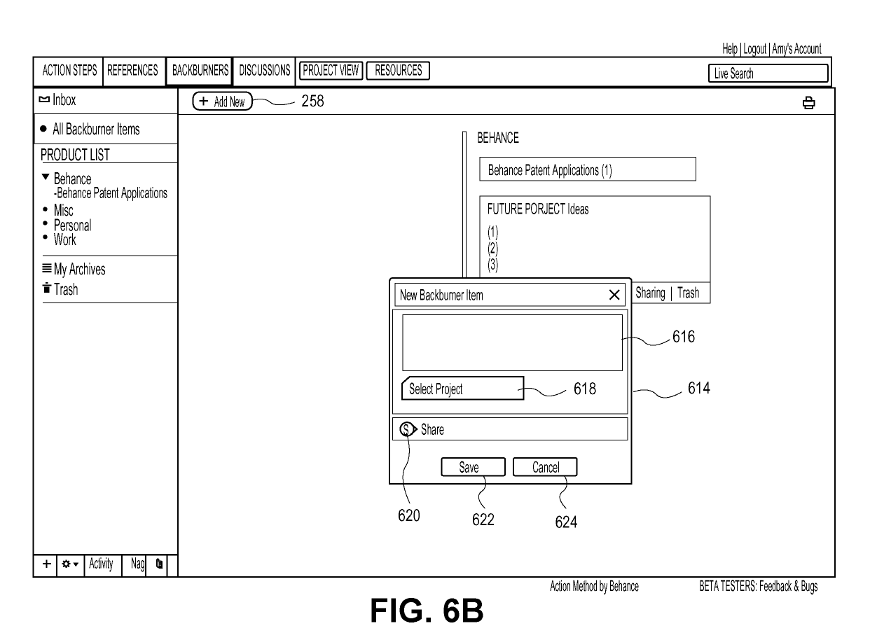

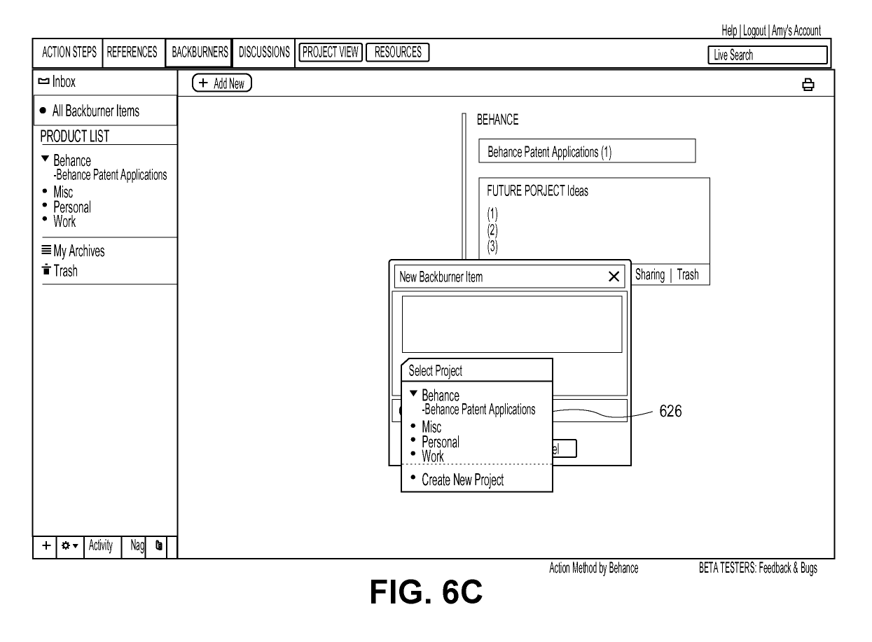

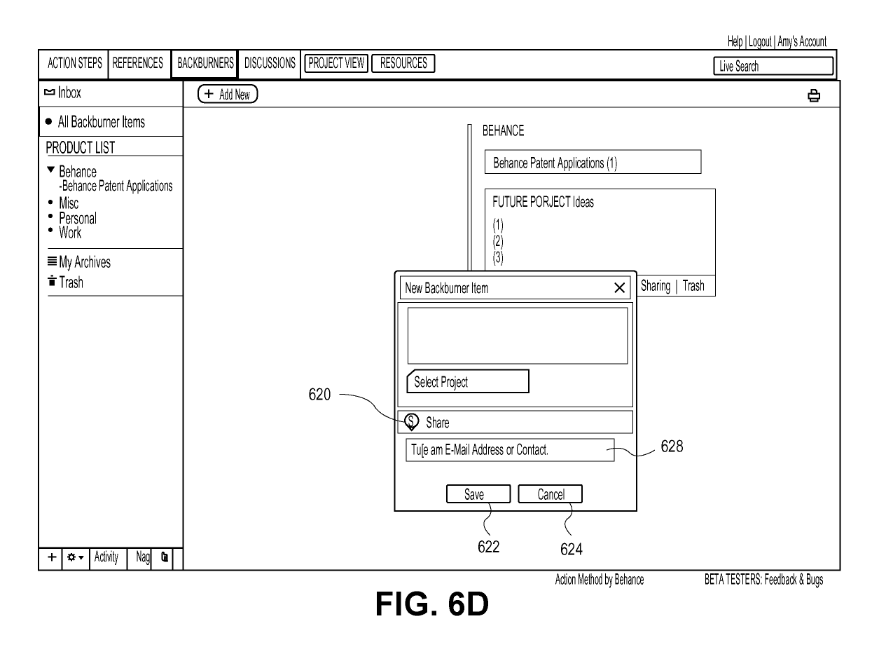

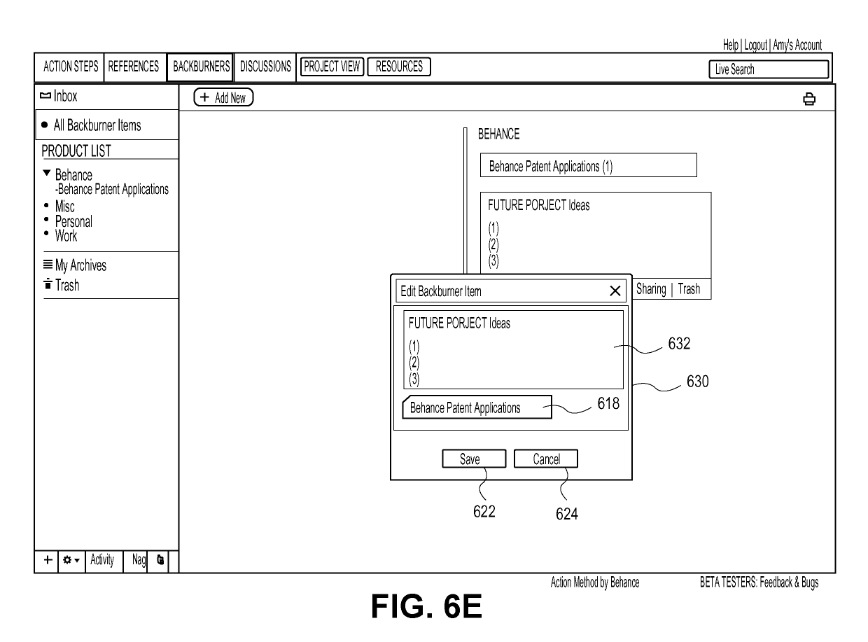

FIGS. 6A-E illustrate exemplary features and functions associated with backburners icon 215. FIG. 6A illustrates an exemplary references GUI 600 displayed when the backburner icon 215 is selected. GUI 600 may include, for example, a project title 602, a sub-project title 604, a backburner item 606, backburner content 607, an edit icon 608, a sharing icon 610, and a trash icon 612.

Project title 602 may be any project title of a user's, such as user A 110, action plan. In exemplary GUI 600, the Behance project is selected as the project to be displayed when the backburners tab 210 is selected. A project may be selected from, for example, project list 286, and may be displayed in for example, menu display 280. When a project is selected, information regarding the references and/or reference items 518 may be displayed on references GUI 500. If a project has one or more sub-projects a project sub-title 516 may also be displayed on references GUI 500. A sub-project may be selected from, for example, project list 286, and may be displayed in for example, menu display 280.

Backburner content 607 may include, the content of backburner item 606. Backburner content 607 may include, for example, a template or default format. Selection of sharing icon 610 may enable a user, such as user A 110, to share a backburner item, such as backburner item 606 with, for example, a contact. Selection of trash icon 612 may enable a user, such as user A 110, to delete or remove a backburner item or portion thereof.

Upon selection of add new icon 258 while backburners GUI 600 is displayed, an add new backburner item window 614 may be displayed, as is shown in FIG. 6B. Add new backburner item window 614 may be, for example, a GUI object. Information entered into new backburner item window 614 may be used to generate a new backburner item 518. New backburner item window 614 may include, for example, text box 616, a project selection menu 618, a share icon 620, a save icon 622 and a cancel icon 624.

A user, such as user A 110, may enter information relating to backburner item 614, into text box 616. Selection of project selection menu 618 allows a user to associate a new backburner item 616 with a project. Selection of project selection menu may display a project drop down menu 626, such as the one displayed in FIG. 6C. The projects displayed in project drop down menu 626 may correspond to the projects displayed in project list 286 as shown in, for example, display menu 280. Selection of save icon 622 may save new backburner item 614 and selection of cancel icon 624 may cancel the process of creating the new backburner item 614.

Selection of share icon 620 may initiate the display of a text box, as shown in exemplary FIG. 6D. A user may enter an email address or contact information into the text box in order to establish with whom they are sharing.

Selection of edit icon 608 may enable a user, such as user A 110, to edit a backburner item, such as backburner item 606. Selection of edit icon 608 may initiate display of edit backburner item GUI window 630. Edit backburner item GUI window 630 may include a text box 632, a project selection icon 618, a save icon 622, and a cancel icon 624. Text box 632 may contain the original content of the backburner item. A user, such as user A 110, may enter changes to the original backburner item within text box 632.

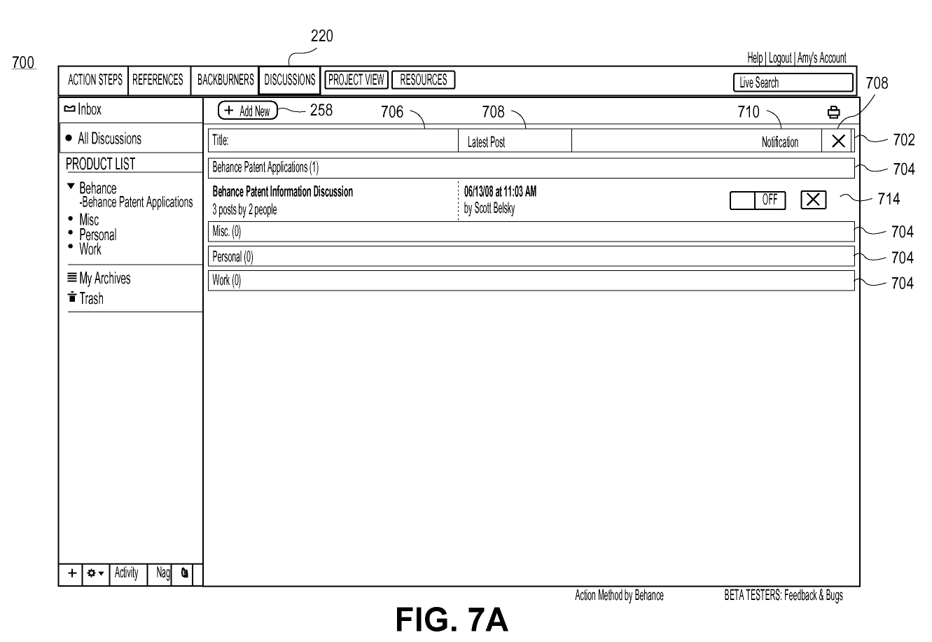

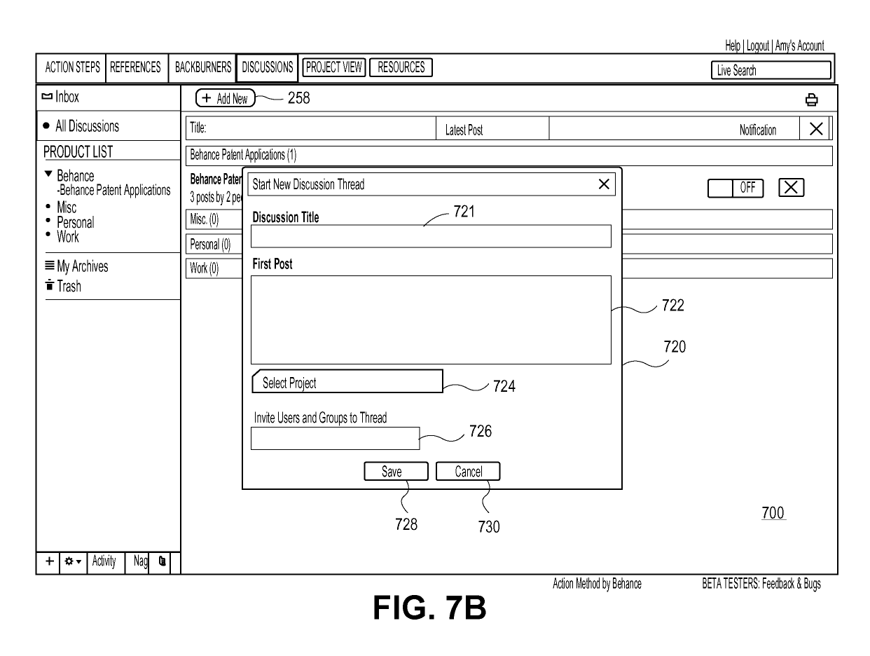

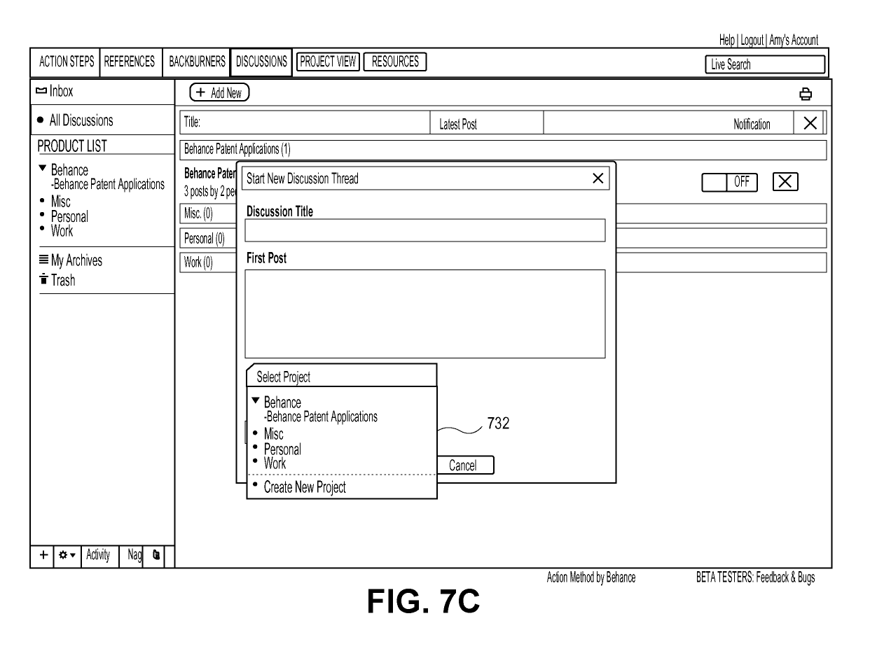

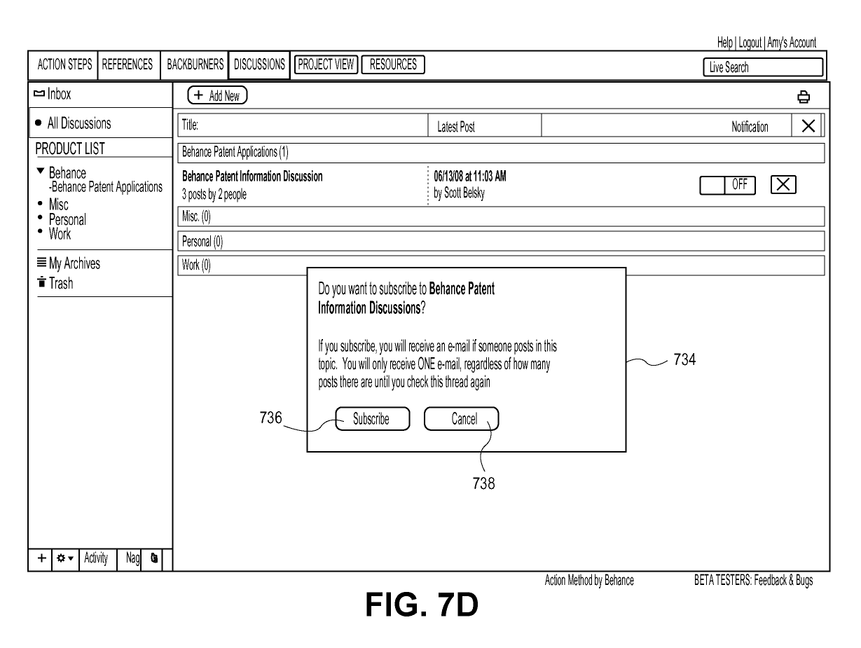

FIGS. 7A-D illustrate exemplary features and functions associated with discussions icon 220. FIG. 7A illustrates an exemplary discussions GUI 700. Exemplary discussions GUI 700 may include a heading bar 702, project title headings 704, and a discussion item 714. Heading bar 702 may include, for example, a title, latest post, notification, and close column. Selection of a project title heading 704 may expand the heading to show discussion items related to the project selected. Exemplary discussion item 714 may include the name of the discussion, the number of posts to the discussion, the number of people posting to the discussion, the time and author of the latest post, a notification selection, and a close discussion item icon.

Upon selection of add new icon 258 while discussions GUI 700 is displayed, an add new discussion item GUI 720 may be displayed, as is shown in FIG. 7B. Information entered into new discussion item window 720 may be used to generate a new discussion item 704. New discussion item window 720 may include, for example, a discussion title text box 721, a first post text box 722, a project selection menu 724, an invite users and groups to thread text box 726, a save icon 728, and a cancel icon 730.

Discussion title text box 721 may be a text box, into which a user, such as user A 110, may enter a title for a new discussion item 720. First post text box 722 may be a text box, into which a user, such as user A 110, may enter a posting for a new discussion item 720. Selection of project selection menu 724 allows a user to associate a new discussion item 720 with a project. Selection of project selection menu 724 may display a project drop down menu 732, such as the one displayed in FIG. 7C. The projects displayed in project drop down menu 732 may correspond to the projects displayed in project list 286 as shown in, for example, display menu 280. Selection of save icon 728 may save the new discussion item 720 and selection of cancel icon 730 may cancel the process of creating the new discussion item 720.

FIG. 7D illustrates an exemplary access discussion subscription box 734. Access discussion subscription box 734 may include a subscribe icon 736 and a cancel icon 738. Selection of subscribe icon 736 may initiate the subscription of a user, such as user A 110, to a discussion. Selection of cancel icon 738 may cancel a user's, such as user A 110, subscription to a discussion.

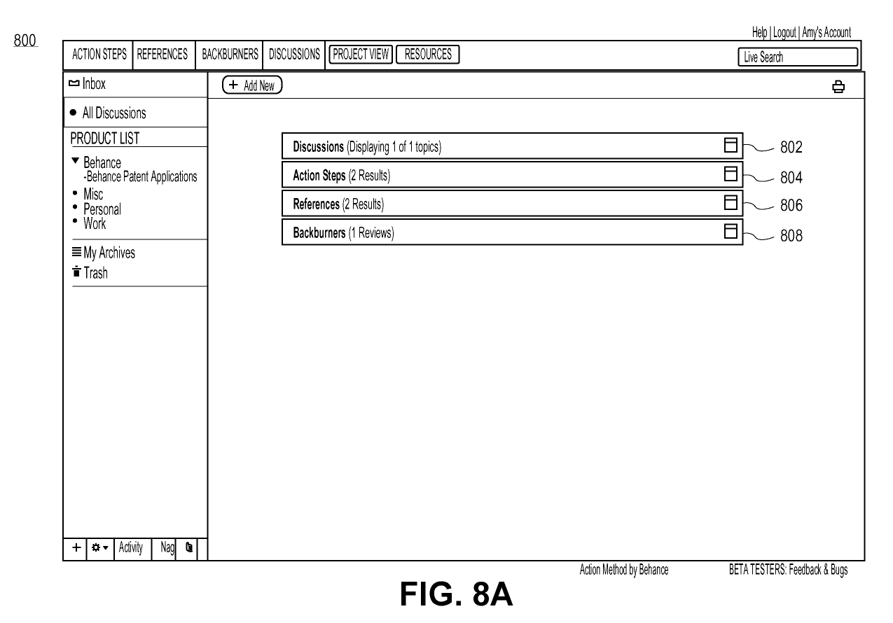

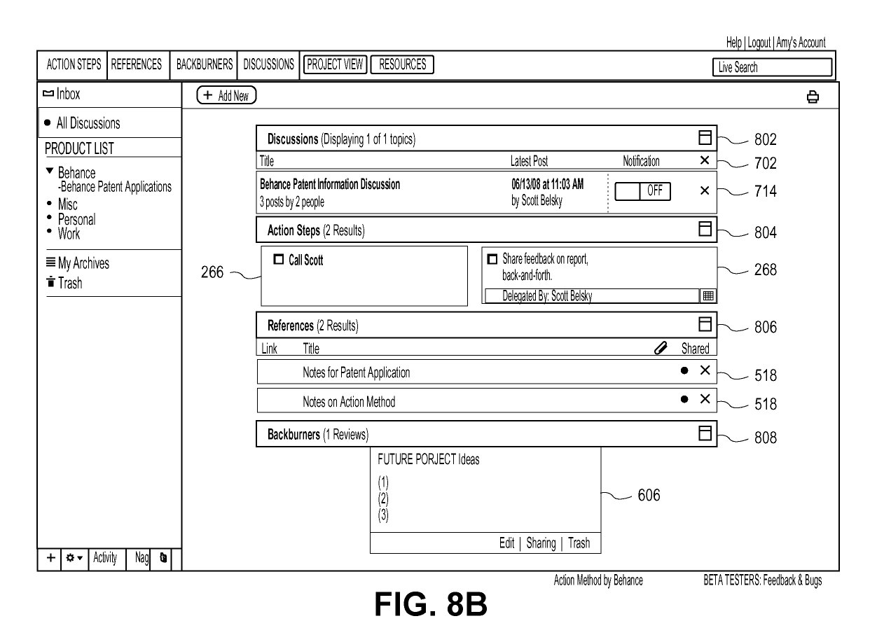

FIGS. 8A-8B illustrate exemplary features and functions associated with project view icon like project view icon 225. Using the project view function, a user may be able to view all items relating to a project and/or an action plan in one GUI. FIG. 8A illustrates a project view GUI 800 associated with the Behance patent project. Project view GUI 800 may include, for example, a discussions icon 802, an action items icon 804, a references icon 806, and a backburners icon 808. Icons 802-808 may include the number of items under each heading and may be expandable, upon, for example, selecting the icon or a portion thereof.

FIG. 8B illustrates an expanded view of icons 802-808. Under discussions icon 802, discussions relating to a selected project or action plan may be displayed. For example, project title heading 702, and discussion item 714 may be displayed. Under action items icon 804, action items related to a selected project or action plan may be displayed. For example, action items 266 and 268 are displayed under action items icon 804. Under references icon 806, reference items relating to a project and/or action plan may be displayed. For example, reference item 518 is displayed on GUI 800. Under backburners icon 808, backburner items relating to a project and/or action plan may be displayed. For example, backburner item 606 is displayed on GUI 800.

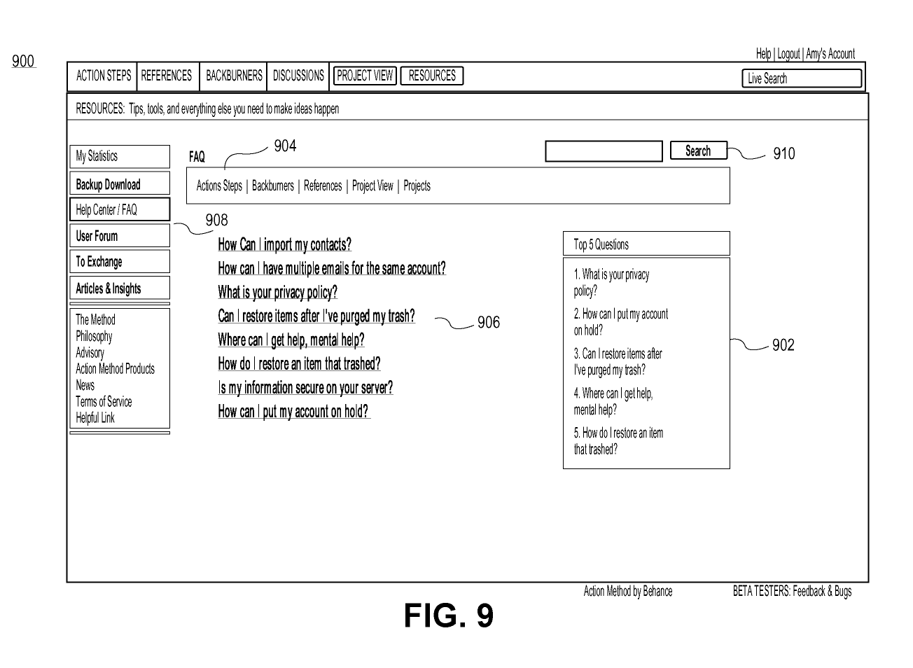

FIG. 9 illustrates exemplary features and functions associated with resources icon, like resources icon 230. FIG. 9 includes resources help GUI 900. Resources help GUI 900 includes a series of icons 904, for example, action items, backburners, references, project view, and/or projects and is displayed upon selection of the help center/FAQ resource from options menu 908. Selection of one of the icons included in series of icons 904 may initiate the display of frequently asked questions 906 regarding the selected icon. Resources GUI 900 may also include an interactive tips and questions menu 902 and/or an options menu 908. Tips and questions menu 902 may include information regarding the selected icon from series of icons 904. Options menu 908 may include different resources for a user, such as user A 110. Exemplary resources include a statistics, backup download, help center FAQ, user forum, tip exchange, and/or articles and insights. Selection of an option included in options menu may initiate the display of a related GUI (not all GUIs are shown).

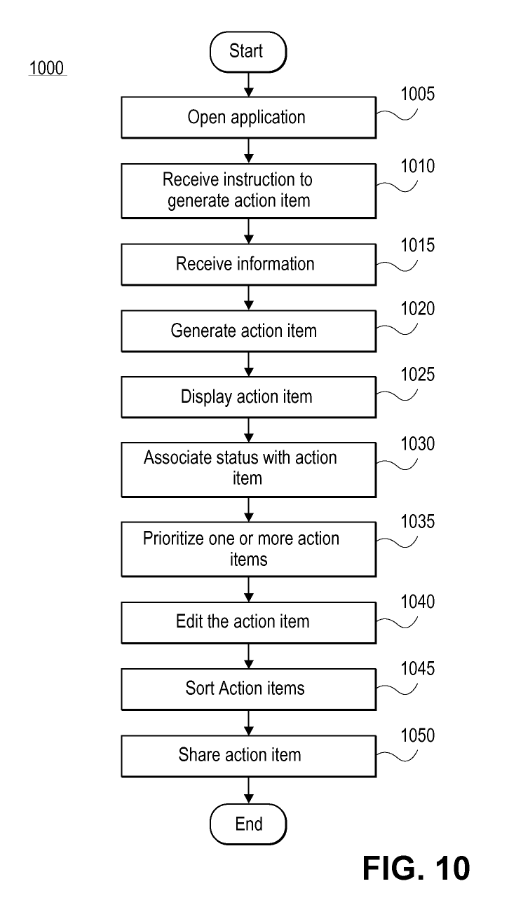

FIG. 10 illustrates an exemplary process 1000 of generating an action item, consistent with an embodiment of the present application, such as action items 266-274. Process 1000 may be performed by, for example, system 100. In step 1005, an application for generating an action plan, such as application 150, may be opened by, for example, a user, such as user A 110. In step 1010, instructions to generate an action item may be received from, for example, a user such as user A 110 and/or an application for generating an action plan, such as, application 150. In step 1015, information regarding the action item may be received from, for example, a user such as user A 110 and/or an application for generating an action plan, such as application 150. The information may include, for example, an identification parameter, a fixed parameter, and/or an adjustable parameter. An action item may then be generated using the received information (step 1020). The generated action item may have a unique identifier. Such a unique identifier may include, for example, one or more identification parameters. The generated action item may then be displayed, via, for example, web browser 120, to a user, such as user A 110 (step 1025).

In some embodiments, a status may be associated with an action item (step 1030). An exemplary status may include, for example, whether the action item has been delegated by or to a user, whether a user is awaiting an acceptance of a delegated action item, or whether an action item is complete. The status of an action item may be, for example, an identification parameter, a fixed parameter, and/or an adjustable parameter. In embodiments with more than one action item, the plurality of action items may be prioritized (step 1035). In step 1040, a parameter of an action item may be edited by, for example, a user, such as user A 110. In some embodiments, a user may be able to edit adjustable variables, while in others, the user may be able to edit fixed variables. A user may need to be authorized prior to editing a fixed variable. A user may not be able to edit an identification parameter. In step 1045, a plurality of action items may be sorted according to, for example, one or more criteria. Exemplary criteria may include completed action items, delegated action items, received action items, or date created. In step 1050, an action item may be shared with another, such as user B 160 and process 1000 may end.

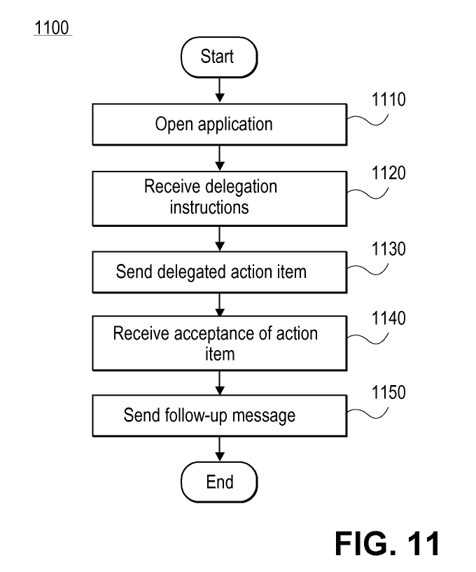

FIG. 11 illustrates an exemplary process 1100 of delegating an action item, such as action items 266-274. Process 1100 may be performed by, for example, system 100. In step 1110, an application for generating and/or delegating an action plan may be opened by, for example, a user, such as user A 110. In step 1120, delegation instructions for an action item may be received from, for example, a user, such as user A 110. Delegation instructions may include instructions to delegate and/or send the action item to another user, such as user B 160. In step 1130, an action item to be delegated may be sent to the delegee, such as user B 160 via, for example, email. A delegated action item may be linked to the delegate such that a change in the status of the action item for the delegee, will be displayed to the delegator, and vise versa. In some embodiments, the delegated action item may be displayed to both the delegator and delegee. In step 1140, a decision regarding the delegate's acceptance, or refusal, of the action item may be received. In step 1150, a follow-up message may be sent to the delegee. The contents of such a message may include, for example, a nag and/or an appreciation. Following step 1150, process 1100 may end.

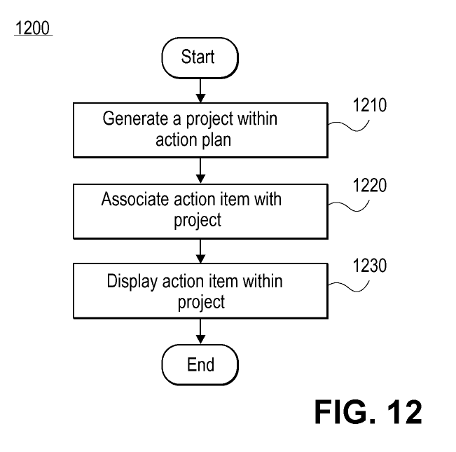

FIG. 12 illustrates an exemplary process 1200 of generating a project, such as projects 286 A-D. Process 1200 may be performed by, for example, system 100. In step 1210, a project may be generated with an action plan. A project may be, for example, a group of related action, discussion, reference, and/or backburner items. The name of a project and/or the contents of a project may be determined by a user, such as user A 110, and in this way, the projects within a user's action plan may be highly personalized.

In step 1220, an action item may be associated with a project. An action item may be associated with a project by, for example, selecting the action item and dragging it across a GUI to a new location. In some embodiments, this new location may be a project listed in a project list, such as project list 268. In step 1230, the action item may be displayed in its associated project. A reference item, backburner item, and/or discussion item may also be associated with a project via a similar process. Following step 1230, process 1200 may end.

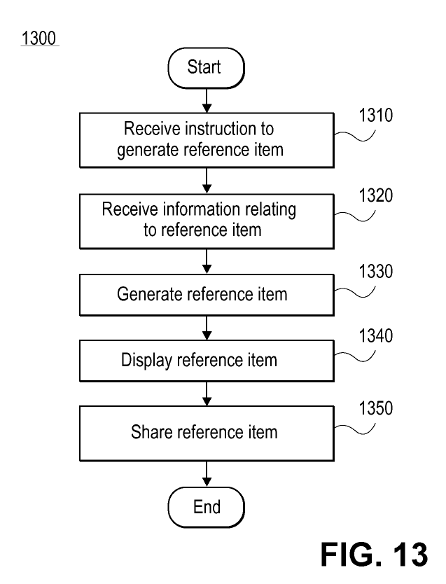

FIG. 13 illustrates an exemplary process 1300 of generating a reference item, such as reference item 518. Process 1300 may be performed by, for example, system 100. In step 1310, instructions to generate a reference item may be received from, for example, a user such as user A 110. In step 1320, information regarding the reference item may be received from, for example, a user such as user A 110. A reference item may then be generated using the received information (step 1330). The generated reference item may then be displayed, via, for example, web browser 120, to a user, such as user A 110 (step 1340). The generated reference item may also be shared with, for example, another user, such as user B 160 (step 1350). Following step 1350, process 1300 may end.

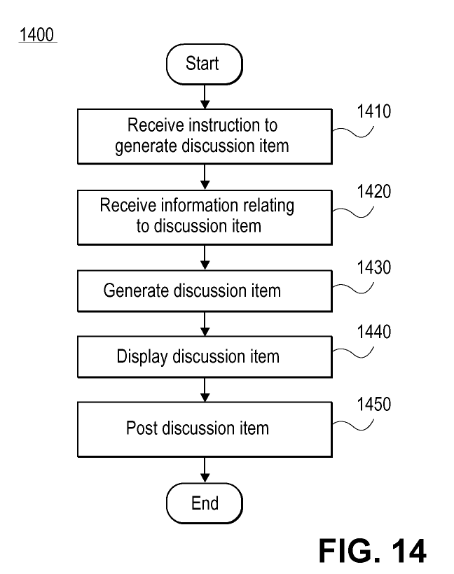

FIG. 14 illustrates an exemplary process 1400 of generating a discussion item, such as discussion item 714. Process 1400 may be performed by, for example, system 100. In step 1410, instructions to generate a discussion item may be received from, for example, a user such as user A 110. In step 1420, information regarding the discussion item may be received from, for example, a user such as user A 110. A discussion item may then be generated using the received information (step 1430). The generated discussion item may then be displayed, via, for example, web browser 120, to a user, such as user A 110 (step 1440). The generated discussion item may also be posted to, for example, a discussion board, where it may be read and/or responded to by another user, such as user B 160 (step 1450). Following step 1450, process 1400 may end.

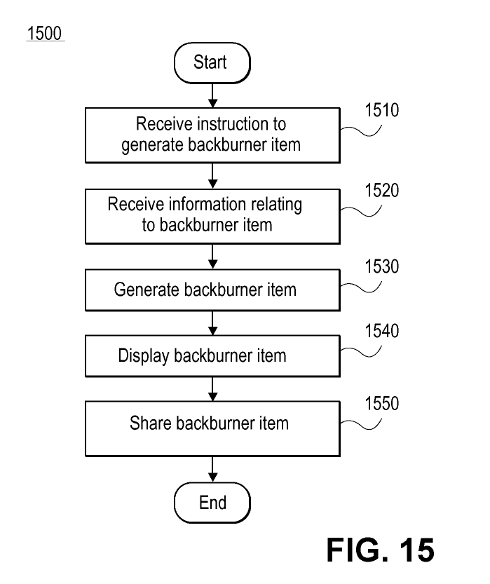

FIG. 15 illustrates an exemplary process 1500 of generating a backburner item, such as backburner item 604. Process 1500 may be performed by, for example, system 100. In step 1510, instructions to generate a backburner item may be received from, for example, a user such as user A 110. In step 1520, information regarding the backburner item may be received from, for example, a user such as user A 110. A backburner item may then be generated using the received information (step 1530). The generated backburner item may then be displayed, via, for example, web browser 120, to a user, such as user A 110 (step 1540). The generated backburner item may also be shared with, for example, another user, such as user B 160 (step 1550).

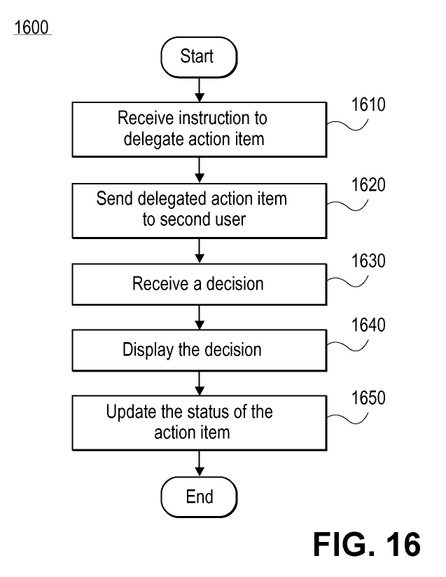

FIG. 16 illustrates an exemplary process 1600 of managing an action plan. Process 1600 may be performed by, for example, system 100. In step 1610, delegation instructions for an action item may be received from, for example, a user, such as user A 110. Delegation instructions may include instructions to delegate and/or send an the action item to another user, such as user B 160. In step 1620, an action item to be delegated may be sent to the delegee, such as user B 160 via, for example, email. In step 1630, a decision regarding the delegee's acceptance, or refusal, of the action item may be received. In step 1640, the decision regarding the delegee's acceptance or refusal of the action item may be displayed in, for example, the action item and/or on a project or activity list. In step 1650 the status of the action item may be updated. This updating may be done periodically or on an as needed basis. Updated status information for an action item may also be displayed. Following step 1650, process 1600 may end.

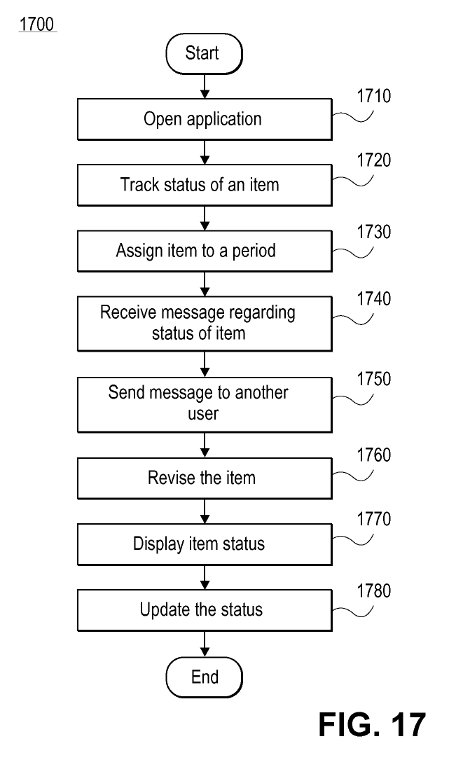

FIG. 17 illustrates an exemplary process 1700 of managing an action plan wherein the action plan includes at least one of an action item, a backburner item, a discussion item, and a reference item. Process 1700 may be performed by, for example, system 100. A plurality of users may contribute to, for example, an action plan and/or components of the action plan, such as a project or action item. In step 1710, an application for managing an action plan, such as application 150, may be opened by, for example, a user, such as user A 110. The action plan may include one or more items. An item may be, for example, an action item, a backburner item, a reference item, or a discussion item.

In step 1720, the status of an item may be tracked, via, for example, a unique identifier and/or an identification parameter associated with the action item. The status of an item may be tracked by, for example, an application for managing an action plan, such as, application 150. The status of an item may include, for example, the current status of the item, a change in the status of the item, when the status changes, when the item is delegated, when the item is accepted, when the item is complete, who completed the item, and/or the status of a related item. The status of an item may also include whether the item has been delegated to another user, such as user B 160. In the example of an action item, the tracking the status of the action item may include tracking the status of, for example, an identifying parameter, a fixed parameter, and/or an adjustable parameter.

In step 1730, an item may be assigned to a project. The name and/or categorization of a project may be specific to a user. Likewise, the assignment of an item into a project may also be specific to a user. For example, suppose there is an action item, for example, action item 268, which has been delegated to a user, such as user A 110, by a second user, such as user B 160. User A 110 may assign action item 268 to a project titled, for example, “Action Items from user B 160,” while a second user, such as user B 160, may assign action item 268 to a project titled, for example, “Delegated Tasks” or “Report.” In this way, a user's project list and the action items assigned to a project list may be highly personalized, yet each user remains linked to the action item and may track its status.

In step 1740, a message regarding the status of an item may be received. The message may be received from, for example, another user, such as user B 160. The message may regard the status of the item and/or a change of status for the item. In step 1750, a message may be sent to another user, for example, user A 110. The message may be in response to the status of an item and may be, for example, a nag or an appreciation. In some embodiments, the item that is the subject of the message may be delegated to a second user.

In step 1760, an item may be revised. In some embodiments, the item may be opened prior to revising it. In step 1770, the status of the item may be displayed to, for example, a user, such as, user A 110 or user B 160. The item may be displayed on, for example, a project list, an activity list, such as activity list 405, or a page displaying a portion of the action plan. In step 1780, the status of the item may be updated to include, for example, any change in the status of the item. The updating may be done, for example, automatically, or on a periodic or as needed basis, and process 1700 may end.

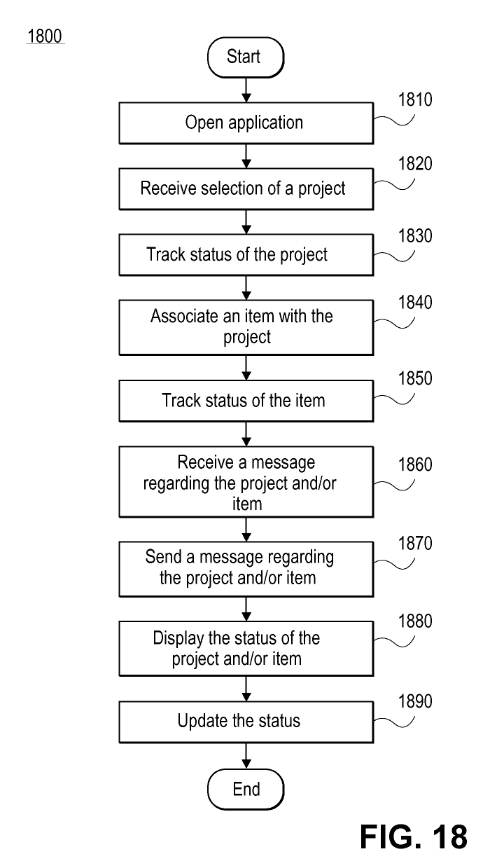

FIG. 18 illustrates an exemplary process 1800 of managing an action plan, consistent with an embodiment of the present application. Process 1800 may be performed by, for example, system 100. In step 1810, an application for managing an action plan, such as application 150, may be opened by, for example, a user, such as user A 110. A plurality of users may contribute to, for example, an action plan and/or components of the action plan, such as a project or action item. The action plan may include one or more projects and/or items. An item may be, for example, an action item, a backburner item, a reference item, or a discussion item. In step 1820, a selection of a project included in the action plan may be received from, for example, a user, such as user 110. In step 1830, the status of a project may be tracked, via, in the case of an action item associated with the project, for example, a unique identifier and/or an identification parameter associated with the action item. The status of a project may include, for example, the current status of the project and/or items included in the project, a change in the status of the project and/or items included in the project, when the status changes, when an item included in the project is delegated, when an item included in the project is accepted, when an item included in the project is complete, who completed the project and/or items included in the project, and/or the status of a related project and/or items related to the project. The status of the project and/or items included in the project may also include whether the project and/or items included in the project have been delegated to another user, such as user B 160. In the example of an action item, tracking the status of the action item may include tracking the status of, for example, an identifying parameter, a fixed parameter, and/or an adjustable parameter.

In step 1840, an item may be assigned to a project. The name and/or categorization of a project may be specific to a user. Likewise, the assignment of an item into a project may also be specific to a user. For example, suppose there is an action item, for example, action item 268, which has been delegated to a user, such as user A 110, by a second user, such as, user B 160. User A 110 may assign action item 268 to a project titled, for example, “Action Items from user B 160,” while user B 160 may assign action item 268 to a project titled, for example, “Delegated Tasks” or “Report.” In this way, a user's project list and the action items assigned to a project list may be highly personalized, yet each user may be linked to the action item may track its status. In step 1850, the status of the item may be tracked, in a manner similar to the tracking of step 1830.

In step 1860, a message regarding the status of the project and/or items included in the project may be received. The message may be received from, for example, another user, such as user B 160. The message may regard the status of the project and/or items included in the project and/or a change of status for the project and/or items included in the project. In step 1870, a message may be sent to another user, for example, user B 160. The message may be in response to the status of the project and/or items included in the project and may be, for example, a nag or an appreciation. In some embodiments, the project and/or items included in the project the message regards may be delegated to a second user.

In step 1880, the status of the project and/or items included in the project may be displayed to, for example, a user, such as, user A 110. The project and/or items included in the project may be displayed on, for example, a project list, an activity list, such as activity list 405, or a page displaying a portion of the action plan. In step 1890, the status of the project and/or items included in the project may be updated to include, for example, any change in the status of the project and/or items included in the project. The updating may be done, for example, automatically, or on a periodic or as needed basis, and process 1800 may end.

Thus, systems, methods, GUIs, and computer readable media for generating and managing an action plan are presented.

What is claimed is:

1. A method implemented using a processor and a memory for generating an action plan for at least one of a first and second user, wherein the action plan includes at least one of an action item and a delegated action item, the method comprising:
opening, by the first user, a first application stored in the memory for generating the action plan;
receiving a first instruction from the first user to generate the action item;
receiving information from the first user relating to the action item;
using the processor to generate the action item using the received information;
receiving a second instruction from the first user to delegate the action item to the second user;
sending the delegated action item to the second user;
opening, by the second user, a second application for generating the action plan;
receiving, by the second user, the delegated action item;
accepting, by the second user, the delegated action item;
displaying the delegated action item on a display device; and
modifying, by the second user, the delegated action item.

2. The method of claim 1, wherein the modifying includes at least one of repositioning the delegated action item within a display, categorizing the delegated action item, editing the delegated action item, and prioritizing the delegated action item.

3. The method of claim 1, further comprising:
delegating the action item to a contact of the user.

4. The method of claim 1, further comprising:
sending a follow-up message related to the delegated action item.

5. The method of claim 1, further comprising:
accessing, by at least one of the first and second users, a project within the action plan, wherein the contents of a project are personalized to at least one of the first user and the second user.

6. The method of claim 5, further comprising:
associating, by at least one of the first user and the second user, at least one of the action item and the delegated action item with the project.

7. The method of claim 1, further comprising:
associating a status with at least one of the action item and the delegated action item; and
updating the status of at least one of the action item and the delegated action item.

8. The method of claim 1, further comprising:
displaying the at least one of the action item and the delegated action item on an activity list, wherein a status is associated with at least one of the action item and the delegated action item; and
displaying the status of at least one of the action item and the delegated action item on the activity list.

9. The method of claim 1, wherein at least one of the action item and the delegated action item is associated with a unique identifier.

10. A graphical user interface (GUI), wherein the GUI is enabled to generate an action plan for at least one of a first user and a second user, wherein the action plan includes at least one of an action item and a delegated action item, the GUI further enabled to:
open, for the first user, an application for generating the action plan;
receive an instruction from the first user to generate the action item;
receive information from the first user relating to the action item;
generate the action item using the received information;
receive instructions from the first user to delegate the action item to the second user;
send the delegated action item to the second user;
open, for the second user, an application for generating the action plan;
receive, from the second user, the delegated action item;
accept, from the second user, the delegated action item; and
receive an instruction to modify the delegated action item from the second user.

11. The GUI of claim 10, wherein the instruction to modify includes at least one of repositioning the delegated action item within a display, categorizing the delegated action item, editing the delegated action item, and prioritizing the delegated action item.

12. The GUI of claim 10, wherein the GUI is further enabled to:
delegate the action item to a contact of the user.

13. The GUI of claim 10, wherein the GUI is further enabled to:
access a project within the action plan, wherein the contents of a project are personalized to at least one of the first user and the second user.

14. The GUI of claim 13, wherein the GUI is further enabled to:
associate at least one of the action item and the delegated action item with the project.

15. A system enabled to generate an action plan for a user, wherein the action plan includes an action item, the system comprising:
a server computing device;
a first application resident on the server computing device, wherein the first application opens, for the first user, a second application that generates the action plan,
receives an instruction to generate the action item from the first user,
receives information relating to the action item from the first user,
generates the action item using the received information,
receives instructions from the first user to delegate the action item to the second user,
sends the delegated action item to the second user,
opens, for the second user, a third application that generates the action plan,
receives from the second user the delegated action item,
accepts, from the second user, the delegated action item, receives an instruction to modify the delegated action item from the second user; and
a web browser, wherein the web browser is enabled to display the generated action item to the user.

16. The system of claim 15, wherein the application further sends a follow-up message related to the delegated action item.

17. The system of claim 15, wherein the application further provides access, to at least one of the first user and the second user, to a project within the action plan, wherein the contents of a project are personalized to at least one of the first user and the second user.

18. The system of claim 17, wherein the application further associates, by at least one of the first user and the second user, at least one of the action item and the delegated action item with the project.

19. A computer program product stored in a computer-readable storage medium which, when executed by a processing arrangement, is configured to generate an action plan for a user, wherein the action plan includes an action item, comprising:
a computer program including:
computer readable program code used to provide for opening, by the first user, of an application for generating the action plan;
computer readable program code used to provide for receiving an instruction from the first user to generate the action item;
computer readable program code used to provide for receiving from the first user information relating to the action item;
computer readable program code used to generate the action item using the received information;
computer readable program code used to provide for receiving instructions, from the first user, to delegate the action item to the second user;
computer readable program code used to send the delegated action item to the second user;
computer readable program code used to provide for opening, by the second user, of an application for generating the action plan;
computer readable program code used to provide for receiving, by the second user, the delegated action item;
computer readable program code used to provide for accepting, by the second user, the delegated action item; and
computer readable program code used to provide for modifying, by the second user, the delegated action item.

20. The computer program product of claim 19, wherein the computer program further includes computer readable program code used to:
delegate the action item to a contact of the user.

21. The computer program product of claim 19, wherein the computer program further includes computer readable program code used to provide for:
accessing, by at least one of the first user and the second user, a project within the action plan, wherein the contents of a project are personalized to at least one of the first user and the second user.

22. The computer program product of claim 21, wherein the computer program further includes computer readable program code used to provide for:
associating, by at least one of the first user and the second user, at least one of the action item and the delegated action item with the project.
